(19) United States
(12) Patent Application Publication
(10) Pub. No.: US 2025/0175309 A1
(43) Pub. Date: May 29, 2025

(54) UPLINK INTERFERENCE IN A COMMUNICATION NETWORK

(71) Applicant: Telefonaktiebolaget LM Ericsson (publ), Stockholm (SE)

(72) Inventors: Adriano MENDO MATEO, MÁLAGA (ES); Jose OUTES CARNERO, Torremolinos (ES); Juan RAMIRO MORENO, MÁLAGA (ES); Yak NG MOLINA, MÁLAGA (ES); Jose Maria RUIZ AVILES, MÁLAGA (ES); Paulo Antonio MOREIRA MIJARES, MÁLAGA (ES); Rakibul ISLAM RONY, MÁLAGA (ES)

(73) Assignee: Telefonaktiebolaget LM Ericsson (publ), Stockholm (SE)

(21) Appl. No.: 18/850,571

(22) PCT Filed: Jun. 8, 2022
(86) PCT No.: PCT/IB2022/055357

§ 371 Date: Sep. 25, 2024

(30) Foreign Application Priority Data
Apr. 26, 2022 (EP) 22382397.2

(51) Int. Cl. H04L 5/00; H04W 24/10; H04W 72/541; H04W 72/542

(52) U.S. Cl. CPC H04L 5/0073; H04L 5/0053; H04W 24/10; H04W 72/541; H04W 72/542

(57) ABSTRACT

A network node (30) obtains downlink measurement reports (32) that are reported by communication devices (12-1 . . . 12-X) to a serving cell (14S) and that each reports a downlink measurement on the serving cell (14S) and a downlink measurement on a neighbor cell (14N). The network node (30) also obtains serving cell resource information (34) indicating, for each of the communication devices (12-1 . . . 12-X), a number of transmission resources utilized by the communication device for uplink traffic (18) on the serving cell (14S). The network node (30) further obtains neighbor cell resource information (36) indicating a number of transmission resources available for uplink traffic (13) on the neighbor cell (14N) and a number of transmission resources utilized for uplink traffic (13) on the neighbor cell (14N). The network node (30) calculates, from the downlink measurement reports (32), the serving cell resource information (34), and the neighbor cell resource information (36), an uplink coupling factor (37) that indicates an extent to which uplink traffic (18) on the serving cell (14S) interferes with uplink traffic (13) on the neighbor cell (14N).

### TECHNICAL FIELD

The present application relates generally to a communication network, and relates more particularly to uplink interference in such a network.

### BACKGROUND

In a communication network, uplink power control dynamically adjusts the respective uplink transmit powers of communication devices, as needed to adapt to channel conditions and uplink interference from other devices. Uplink power control improves network performance in terms of reliability (e.g., dropped connection rate) and user throughput.

Uplink power control proves quite complex, however. Increasing the uplink transmit power for communication devices transmitting on one cell would improve performance for those devices, but it would increase the uplink interference experienced by communication devices in a neighbor cell, negatively impacting their performance. Without a way to accurately determine the extent to which uplink interference would be increased for communication devices in a neighbor cell, though, uplink power control remains suboptimal. A need remains therefore for uplink power control that accounts for the impact that increased transmit power in one cell would have on the uplink interference in a neighbor cell.

### SUMMARY

Some embodiments herein provide an uplink coupling factor that indicates an extent to which uplink traffic on a serving cell interferes with uplink traffic on a neighbor cell. In some embodiments, for example, the uplink coupling factor may be determined from downlink measurement reports, serving cell resource information, and neighbor cell resource information, e.g., assuming downlink-uplink reciprocity. Regardless, equipped with such an uplink coupling factor, some embodiments control uplink power in the serving cell in a way that accounts for the extent to which uplink transmit power in the serving cell would impact uplink interference in the neighbor cell. Some embodiments thereby advantageously provide improved system performance.

More particularly, embodiments herein include a method performed by a network node configured for use in a communication network. The method comprises obtaining downlink measurement reports that are reported by communication devices to a serving cell and that each reports a downlink measurement on the serving cell and a downlink measurement on a neighbor cell. The method also comprises obtaining serving cell resource information indicating, for each of the communication devices, a number of transmission resources utilized by the communication device for uplink traffic on the serving cell. The method also comprises obtaining neighbor cell resource information indicating a number of transmission resources available for uplink traffic on the neighbor cell and a number of transmission resources utilized for uplink traffic on the neighbor cell. The method also comprises calculating, from the downlink measurement reports, the serving cell resource information, and the neighbor cell resource information, an uplink coupling factor that indicates an extent to which uplink traffic on the serving cell interferes with uplink traffic on the neighbor cell.

In some embodiments, calculating the uplink coupling factor comprises selecting, from the downlink measurement reports, a subset of downlink measurement reports that, assuming downlink-uplink reciprocity, each indicate uplink traffic on the serving cell interferes with uplink traffic on the neighbor cell. Calculating the uplink coupling factor also comprises, for each downlink measurement report in the subset, calculating, as a function of the serving cell resource information and the neighbor cell resource information, an uplink coupling factor component associated with the downlink measurement report. Calculating the uplink coupling factor further comprises calculating the uplink coupling factor as a function of the uplink coupling factor components.

In one or more of these embodiments, calculating the uplink coupling factor component for each downlink measurement report in the subset comprises, for each downlink measurement report in the subset, determining, as a function of the serving cell resource information, a number of transmission resources associated with the downlink measurement report. Calculating the uplink coupling factor component for each downlink measurement report in the subset also comprises, for each downlink measurement report in the subset, calculating the uplink coupling factor component associated with the downlink measurement report as a function of the number of transmission resources associated with the downlink measurement report. For example, in some embodiments, calculating the uplink coupling factor component for each downlink measurement report in the subset comprises, for each downlink measurement report in the subset, calculating a report-specific resource utilization metric as a function of the number of transmission resources associated with the downlink measurement report, and calculating the uplink coupling factor component associated with the downlink measurement report as a function of the report-specific resource utilization metric. In one such embodiment, where the serving cell resource information also indicates a number of transmission resources available for uplink traffic on the serving cell, the report-specific resource utilization metric calculated for a downlink measurement report in the subset is a ratio between the number of transmission resources associated with the downlink measurement report and the number of transmission resources available for uplink traffic on the serving cell.

In some embodiments, the serving cell resource information indicates, for each of the communication devices and for each of multiple resource information event periods, a number of transmission resources utilized by the communication device for uplink traffic on the serving cell during the resource information event period. And, the number of transmission resources available for uplink traffic on the serving cell is the number of transmission resources available for uplink traffic on the serving cell across the multiple resource information event periods. In one such embodiment, for each downlink measurement report in the subset, determining the number of transmission resources associated with the downlink measurement report comprises (i) determining, from among the multiple resource information event periods, a resource information event period within which the downlink measurement report was reported; (ii) determining a set of one or more downlink measurement reports reported within the determined resource information event period; (iii) determining a number of transmission resources associated with the set as a function of the number of transmission resources utilized during the determined resource information event period for uplink traffic on the serving cell by the communication device which reported the downlink measurement report; and (iv) equally distributing the number of transmission resources associated with the set among the one or more downlink measurement reports included in the set, with each downlink measurement report included in the set being associated with the number of transmission resources distributed to that downlink measurement report. In one or more of these embodiments, determining the number of transmission resources associated with the set comprises (i) scaling, by a scaling factor, the number of transmission resources utilized during the determined resource information event period for uplink traffic on the serving cell by the communication device which reported the downlink measurement report; and (ii) determining the number of transmission resources associated with the set to be equal to the scaled number. For example, in embodiments where the serving cell resource information also indicates, for each of the multiple resource information event periods, a number of transmission resources utilized for uplink traffic on the serving cell collectively by communication devices served by the serving cell during the resource information event period, the scaling factor may be a ratio of (i) the number of transmission resources utilized for uplink traffic on the serving cell collectively by communication devices served by the serving cell during the determined resource information event period; and (ii) a sum of the numbers of transmission resources respectively utilized by the communication devices for uplink traffic on the serving cell during the resource information event period.

In some embodiments, calculating the uplink coupling factor component associated with the downlink measurement report as a function of the report-specific resource utilization metric comprises calculating the uplink coupling factor component associated with the downlink measurement report to be proportional to the report-specific resource utilization metric.

In some embodiments, calculating the uplink coupling factor component for each downlink measurement report in the subset comprises, for each downlink measurement report in the subset, calculating the uplink coupling factor component associated with the downlink measurement report also as a function of the number of transmission resources utilized for uplink traffic on the neighbor cell. In one or more of these embodiments, calculating the uplink coupling factor component for each downlink measurement report in the subset comprises, for each downlink measurement report in the subset calculating a neighbor cell resource utilization metric as a function of the number of transmission resources available for uplink traffic on the neighbor cell and the number of transmission resources utilized for uplink traffic on the neighbor cell, and calculating the uplink coupling factor component associated with the downlink measurement report as a function of the neighbor cell resource utilization metric. In one or more of these embodiments, the neighbor cell resource utilization metric is a ratio of the number of transmission resources utilized for uplink traffic on the neighbor cell to the number of transmission resources available for uplink traffic on the neighbor cell. In one or more of these embodiments, calculating the uplink coupling factor component associated with the downlink measurement report as a function of the neighbor cell resource utilization metric comprises calculating the uplink coupling factor component associated with the downlink measurement report to be proportional to the neighbor cell resource utilization metric.

In some embodiments, calculating the uplink coupling factor as a function of the uplink coupling factor components comprises calculating the uplink coupling factor as a sum of the uplink coupling factor components.

In some embodiments, selecting the subset of downlink measurement reports comprises, for each of the downlink measurement reports, (i) calculating, as a function of the downlink measurements on the serving cell and the neighbor cell reported by the downlink measurement report, and as a function of uplink-downlink reciprocity information, a metric representing a relation between an uplink measurement on the serving cell and an uplink measurement on the neighbor cell; and (ii) selecting the downlink measurement report for inclusion in the subset if the metric is less than a threshold. In one or more of these embodiments, the relation is a ratio in a linear domain. In some embodiments, the uplink-downlink reciprocity information includes a maximum transmission power on the serving cell and a power offset between power to be applied to transmission resources carrying a reference signal measured by downlink measurements on the serving cell and power to be applied to transmission resources not carrying the reference signal.

In some embodiments, the method further comprises controlling uplink power in the serving cell based on the uplink coupling factor. In one or more of these embodiments, said controlling comprises generating a model of uplink power in the serving cell using the uplink coupling factor and controlling uplink power in the serving cell based on the model.

In some embodiments, the method further comprises transmitting the uplink coupling factor to another node in the communication network.

In some embodiments, the serving cell resource information indicates, for each of the communication devices and for each of multiple resource information event periods, a number of transmission resources utilized by the communication device for uplink traffic on the serving cell during the resource information event period. In some embodiments, obtaining the serving cell resource information comprises obtaining device resource information indicating, for each of the communication devices and for each of multiple device information event periods, a number of transmission resources utilized by the communication device for uplink traffic on the serving cell during the device information event period. Obtaining the serving cell resource information in this case comprises obtaining the serving cell resource information by, for each of the communication devices and for each of the multiple resource information event periods, (i) determining a set of device information event periods for the communication device that occur during the resource information event period; and (ii) calculating the number of transmission resources utilized by the communication device for uplink traffic on the serving cell during the resource information event period by aggregating the numbers of the transmission resources utilized by the communication device for uplink traffic on the serving cell during the respective device information event periods in the determined set. In one embodiment, for example, the serving cell resource information also indicates, for each of the multiple resource information event periods, a number of transmission resources utilized for uplink traffic on the serving cell collectively by communication devices served by the serving cell during the resource information event period.

Other embodiments herein include a network node configured to perform any of the steps described above.

Other embodiments herein include a network node comprising processing circuitry configured to perform any of the steps described above.

Other embodiments herein include a network node comprising communication circuitry and processing circuitry. The processing circuitry is configured to perform any of the steps described above.

Other embodiments herein include a network node comprising processing circuitry configured to perform any of the steps described above. The network node also comprises power supply circuitry configured to supply power to the network node.

Other embodiments herein include a network node comprising processing circuitry and memory. The memory contains instructions executable by the processing circuitry whereby the network node is configured to perform any of the steps described above.

In some embodiments, the network node is a base station.

Other embodiments herein include a computer program comprising instructions which, when executed by at least one processor of a network node, causes the network node to carry out the steps described above.

In some embodiments, the network node is a base station. In one or more of these embodiments, the carrier is one of an electronic signal, optical signal, radio signal, or computer readable storage medium.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a network node in a communication network according to some embodiments.

FIG. 2 is a block diagram of an uplink coupling factor calculator of a network node according to some embodiments.

FIG. 3 is a block diagram of a uplink coupling factor calculator of a network node according to some embodiments.

FIG. 4 is a block diagram of a report selector of a network node according to some embodiments.

FIG. 5 is a block diagram of an uplink coupling factor component calculator of a network node according to some embodiments.

FIG. 6 is a block diagram of a report-specific resource information extractor of a network node according to some embodiments.

FIG. 7 is a block diagram of an ULCF calculator calculating an uplink coupling factor based on CM parameters and CTR information obtained from OSS according to some embodiments.

FIG. 8 is a logic flow diagram of a method for calculating an uplink coupling factor based on CM parameters and CTR information according to some embodiments.

FIG. 9 is a call flow diagram for distributed uplink coupling factor calculation according to some embodiments.

FIG. 10 is a block diagram of uplink coupling factor calculation in an O-RAN based network according to some embodiments.

FIG. 11 is a block diagram of UL power control optimization using the uplink coupling factor according to some embodiments.

FIG. 12 is a logic flow diagram of a method performed by a network node according to some embodiments.

FIG. 13 is a block diagram of a network node according to some embodiments.

FIG. 14 is a block diagram of a communication system in accordance with some embodiments

FIG. 15 is a block diagram of a user equipment according to some embodiments.

FIG. 16 is a block diagram of a network node according to some embodiments.

FIG. 17 is a block diagram of a host according to some embodiments.

FIG. 18 is a block diagram of a virtualization environment according to some embodiments.

FIG. 19 is a block diagram of a host communicating via a network node with a UE over a partially wireless connection in accordance with some embodiments.

### DETAILED DESCRIPTION

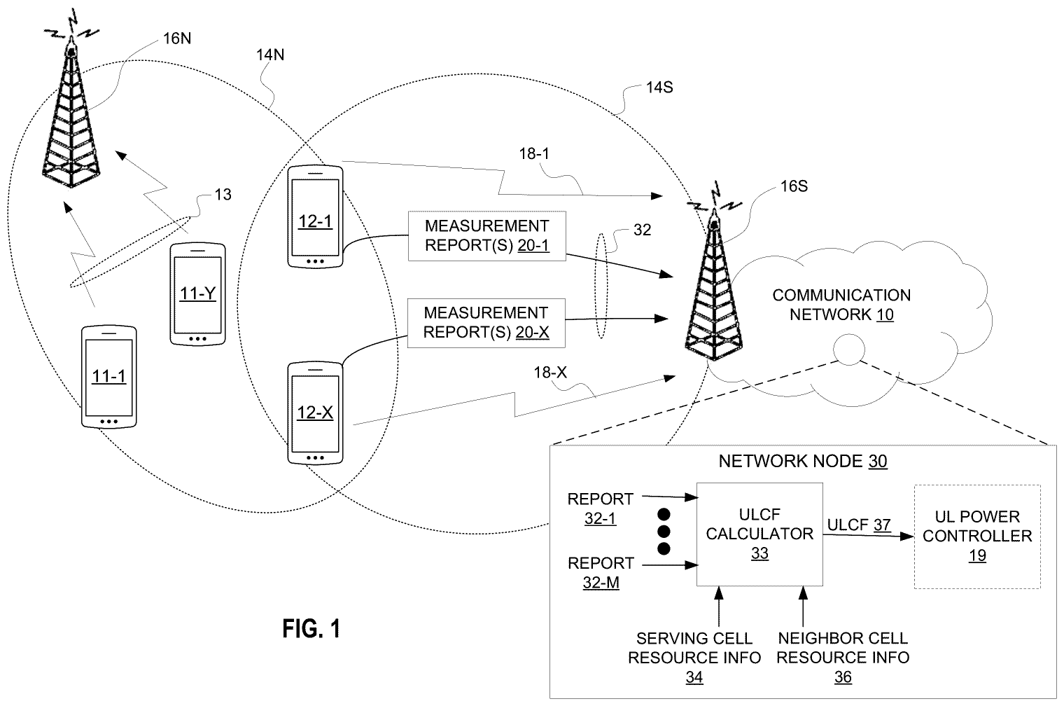

FIG. 1 shows a communication network 10 according to some embodiments, e.g., a 5G network, such as a wireless communication network. The communication network 10 provides communication service to communication devices, e.g., in the form of user equipments (UEs).

FIG. 1 in this regard shows communication devices 12-1 . . . 12-X are served by a serving cell 14S, as provided by a serving access point 16S, e.g., a radio network node. Communication devices 12-1 . . . 12-X perform respective transmissions of uplink traffic 18-1 . . . 18-X on the serving cell 14S, as scheduled and otherwise controlled by the serving access point 16S. The uplink traffic 18-1 . . . 18-X (collectively, uplink traffic 18) may for instance convey uplink user data (e.g., application layer data) and/or be conveyed on a data channel (e.g., a Physical Uplink Shared Channel, PUSCH). Regardless, the serving access point 16S allocates communication devices 12-1 . . . 12-X respective transmission resources to be utilized for these transmissions of uplink traffic 18-1 . . . 18-X on the serving cell 14S. The transmission resources may for instance take the form of time-frequency resources, code resources, spatial resources, or any other type of resource allocable for transmission of uplink traffic. In one specific example, a transmission resource is or corresponds to a physical resource block (PRB) that comprises a block of time-frequency resources, e.g., 12 consecutive frequency subcarriers in one slot (e.g., 0.5 ms) that spans 7 symbols in time.

FIG. 1 further shows other communication devices 11-1 . . . 11-Y are served by a neighbor cell 14N that neighbors the serving cell 14S (at least from a radio propagation perspective). FIG. 1 depicts this neighbor cell 14N as being provided by a neighbor access point 16N different than the serving access point 16S, but in other examples the same access point may provide both the serving cell 14S and the neighbor cell 14N. Regardless, the other communication devices 11-1 . . . 11-Y likewise perform respective transmissions of uplink traffic 13 on the neighbor cell 14N, as scheduled and otherwise controlled by the neighbor access point 16N.

To assist the serving access point 16S with control of transmissions in the serving cell 14S, the communication devices 12-1 . . . 12-X served by the serving cell 14S provide the serving access point 16S with downlink measurement reports, i.e., so as to report the downlink measurement reports to the serving cell 14S. As shown, for instance, communication device 12-1 reports one or more downlink measurement reports 20-1 over some time period, communication device 12-X reports one or more downlink measurement reports 20-X over that same time period, etc. Collectively, over the time period and across the communication devices 12-1 . . . 12-X, FIG. 1 shows that communication devices 12-1 . . . 12-X report downlink measurement reports 32.

In the example of FIG. 1, each of the downlink measurement reports 32 reports a downlink measurement on the serving cell 14S and a downlink measurement on a neighbor cell 14N that neighbors the serving cell 14S (at least from a radio propagation perspective). The downlink measurements may for example be measurements of the strength and/or quality of downlink reference signals (not shown) transmitted respectively on the serving cell 14S and the neighbor cell 14N. At least some of the downlink measurement reports 32 may also report a downlink measurement on one or more other neighbor cells not shown, but for purposes of illustration the example focuses only on the serving cell 14S and neighbor cell 14N. In practice, some communication devices served by the serving cell 14S may not be within coverage of the neighbor cell 14N and so would not report downlink measurements of the neighbor cell 14N, but, again, for purposes of illustration the example in FIG. 1 focuses only on communication devices 12-1 . . . 12-X whose downlink measurement reports 32 report downlink measurements on both the serving cell 14S and the neighbor cell 14N.

According to embodiments herein, a network node 30 in the communication network 10 exploits these downlink measurement reports 32 to calculate a so-called uplink (UL) coupling factor (ULCF) 37 that indicates an extent to which uplink traffic 18 on the serving cell 14S interferes with uplink traffic 13 on the neighbor cell 14N. The ULCF 37 thereby quantifies this extent so as to represent a measure of how much uplink traffic 18 on the serving cell 14S interferes with uplink traffic 13 on the neighbor cell 14N. For example, a greater value for the ULCF 37 may indicate that uplink traffic 18 on the serving cell 14S interferes with uplink traffic 13 on the neighbor cell 14N to a relatively greater extent and a lesser value for the ULCF 37 may indicate that uplink traffic 18 on the serving cell 14S interferes with uplink traffic 13 on the neighbor cell 14N to a relatively lesser extent, at least for the same uplink traffic configuration parameters (e.g., for the same uplink transmit power parameters).

In some embodiments, the communication network 10 exploits this ULCF 37 to control UL power in the serving cell 14S. For example, the network node 30 itself may include an UL power controller 19 that controls uplink power in the serving cell 14S based on the ULCF 37. The UL power controller 19 may for example generate a model of uplink power in the serving cell 14S using the ULCF 37, e.g., based on machine learning, and control UL power in the serving cell 14S based on this model. In other embodiments, though, the network node 30 may simply transmit the ULCF 37 to another node in the communication network 10, e.g., where that other node is similarly configured to control uplink power in the serving cell 14S based on the ULCF 37. In either case, the communication network 10 may use the ULCF 37 to control the uplink power in the serving cell 14S in a way that accounts for the impact that uplink transmit power in the serving cell 14S has on uplink interference in the neighbor cell 14N. In doing so, the communication network 10 advantageously provides improved performance across the serving cell 14S and the neighbor cell 14N.

Note that, in some embodiments, the network node 30 in FIG. 1 is or controls the serving access point 16S that provides the serving cell 14S. In other embodiments, the network node 30 is a separate node or is a centralized node that calculates uplink coupling factors for multiple cells.

More particularly with regard to calculation of the ULCF 37, FIG. 1 shows that the network node 30 includes an ULCF calculator 33 that calculates the ULCF 37. The ULCF calculator 33 calculates the ULCF 37 from the downlink measurement reports 32 reported to the serving cell 14S, where these downlink measurement reports 32 are shown as reports 32-1 . . . 32-M. The ULCF calculator 33 calculates the ULCF 37 also from so-called serving cell resource information 34 and neighbor cell resource information 36.

The serving cell resource information 34 includes information about transmission resources for the serving cell 14S. The serving cell resource information 34 may for example indicate, for each of the communication devices 12-1 . . . 12-X, a number of transmission resources utilized by the communication device for uplink traffic 18 on the serving cell 14S. The serving cell resource information 34 in this case indicates per-device resource utilization for uplink traffic 18 on the serving cell 14S. Here, a transmission resource is utilized by a communication device for uplink traffic 18 on the serving cell 14S if the serving cell 14S allocates the transmission resource to the communication device for transmission of uplink traffic 18 and if the communication device actually transmits uplink traffic 18 on the allocated transmission resource.

The neighbor cell resource information 36, by contrast, includes information about transmission resources for the neighbor cell 14N. The neighbor cell resource information 36 in some embodiments, for example, indicates the number of transmission resources available for uplink traffic 13 on the neighbor cell 14N and the number of transmission resources utilized for uplink traffic 13 on the neighbor cell 14N. The number of transmission resources utilized for uplink traffic 13 on the neighbor cell 14N may be indicated in terms of the number of transmission resources collectively utilized by communication devices 11-1 . . . 11-Y for uplink traffic 13 on the neighbor cell 14N, i.e., the number of transmission resources utilized across communication devices 11-1 . . . 11-Y. Alternatively or additionally, the number of transmission resources available for uplink traffic 13 on the neighbor cell 14N may be indicated in terms of the number of transmission resources that are spanned by a frequency bandwidth of the neighbor cell 14N and that are allocable for an uplink traffic channel of the neighbor cell 14N.

In some embodiments, the ULCF calculator 33 assumes reciprocity between the uplink and downlink in the communication network 10 in order to exploit the downlink measurement reports 32 as being representative of uplink measurements on the serving cell 14S and the neighbor cell 14N. In this case, each downlink measurement report 32 reflects uplink measurements that indicate whether uplink traffic 18 on the serving cell 14S interferes with uplink traffic 13 on the neighbor cell 14N. For example, an uplink measurement on the serving cell 14S being similar to an uplink measurement on the neighbor cell 14N suggests that uplink traffic 18 on the serving cell 14S interferes with uplink traffic 13 on the neighbor cell 14N. Each downlink measurement report 32 that indicates uplink traffic 18 on the serving cell 14S interferes with uplink traffic 13 on the neighbor cell 14N thereby effectively reflects a separate snapshot or instance of uplink interference to the neighbor cell 14N. For each separate snapshot or instance of uplink interference, the ULCF calculator 33 may use the serving cell resource information 34 and the neighbor cell resource information 36 to quantify the extent of the uplink interference.

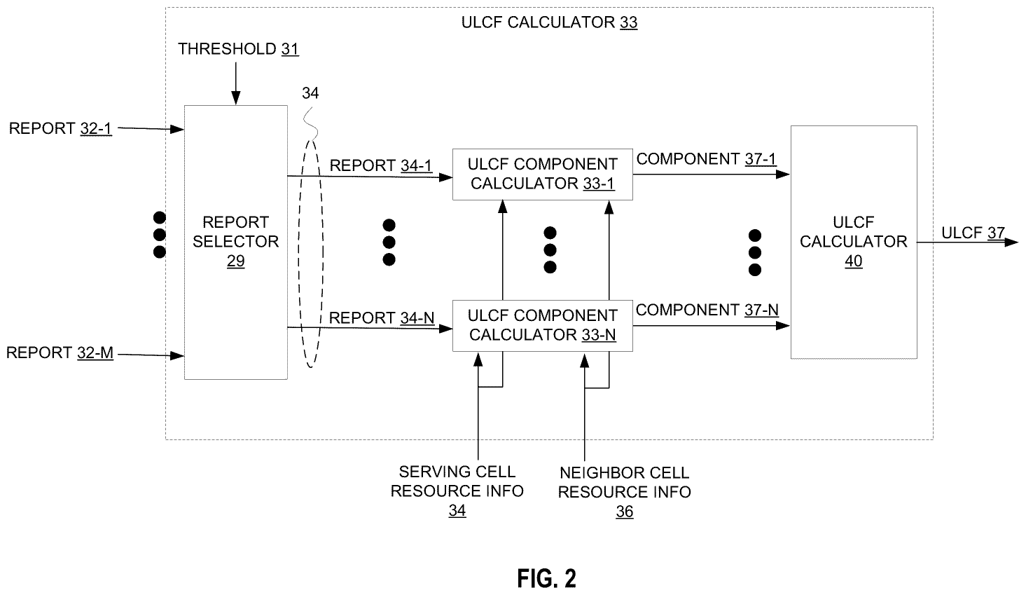

FIG. 2 illustrates additional details of the ULCF calculator 33 according to some embodiments in this regard. As shown, the ULCF calculator 33 includes a report selector 29. The report selector 29 selects, from the downlink measurement reports 32-1 . . . 32-M, a subset 34 of downlink measurement reports that, assuming downlink-uplink reciprocity, each indicate uplink traffic 18 on the serving cell 14S interferes with uplink traffic 13 in the neighbor cell 14N. The selected subset 34 thereby includes downlink measurement reports 34-1 . . . 34-N that each indicate uplink traffic 18 on the serving cell 14S interferes with uplink traffic 13 in the neighbor cell 14N. In one embodiment, then, each downlink measurement report in the subset 34 effectively reflects a separate snapshot or instance of uplink interference to the neighbor cell 14N, with the ULCF 37 reflecting the accumulation or combination of these separate snapshots or instances of uplink interference.

More particularly in this regard, for each downlink measurement report 34-1 . . . 34-N in the subset 34, the ULCF calculator 33 calculates an uplink coupling factor component associated with the downlink measurement report. As shown in FIG. 2, for example, the ULCF calculator 33 includes ULCF component calculators 33-1 . . . 33-N that calculate respective uplink coupling factor components 37-1 . . . 37-N associated with the downlink measurement reports 34-1 . . . 34-N in the selected subset 34. That is, ULCF component calculator 33-1 calculates an uplink coupling factor component 37-1 associated with downlink measurement report 34-1, and ULCF component calculator 33-N calculates an uplink coupling factor component 37-N associated with downlink measurement report 34-N. The ULCF components 37-1 . . . 37-N represent components of uplink coupling between the cells 14S, 14N as reflected by respective ones of the downlink measurement reports 34-1 . . . 34-N in the selected subset 34. In some embodiments, as shown, the ULCF component calculators 33-1 . . . 3-N calculate the respective uplink coupling factor components 37-1 . . . 37-N as a function of the serving cell resource information 34 and the neighbor cell resource information 36.

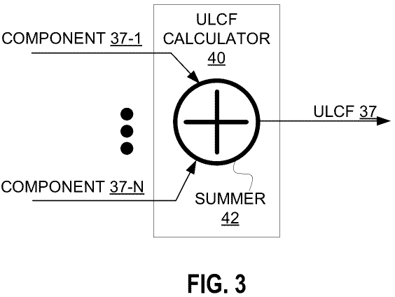

Having calculated the uplink coupling factor components 37-1 . . . 37-N, the ULCF calculator 33 as shown includes an ULCF calculator 40 that calculates the ULCF 37 as a function of the uplink coupling factor components 37-1 . . . 37-N. As shown in FIG. 3, for example, the ULCF calculator 40 may include a summer 42 that calculates the ULCF 37 as the sum of the uplink coupling factor components 37-1 . . . 37-N. In this case, then, the ULCF calculator 40 calculates the ULCF 37 according to:

$$ULCF = {\sum }_{n = 1}^{N} {ULCF}_{n}$$

where ULCF is the ULCF 37 and ULCFₙ is the uplink coupling factor component 37-n for downlink measurement report 34-n. In these and other embodiments, the uplink coupling factor components 37-1 . . . 37-N effectively quantify the extent of uplink interference to the neighbor cell 14N in respective snapshots or instances of uplink interference, and the ULCF 37 reflects the accumulation or combination of the uplink coupling factor components 37-1 . . . 37-N.

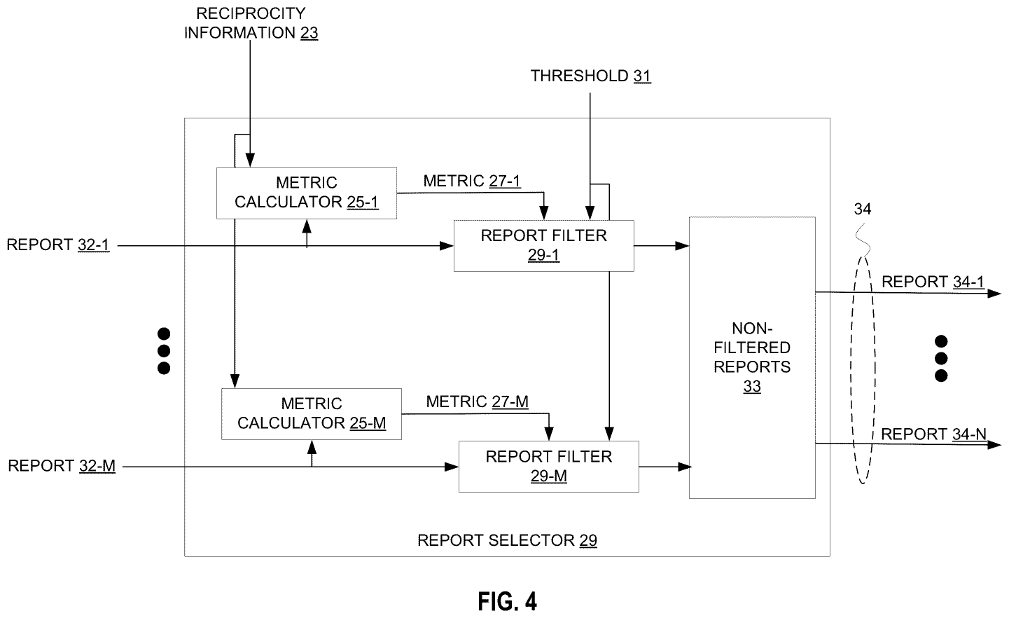

Consider now additional details of the report selector 29, as shown in FIG. 4. The report selector 29 in some embodiments obtains uplink-downlink reciprocity information 23. The uplink-downlink reciprocity information 23 may include, for example, a maximum transmission power on the serving cell 14S and a power offset between power to be applied to transmission resources carrying a reference signal measured by downlink measurements on the serving cell 14S and power to be applied to transmission resources not carrying the reference signal.

The report selector 29 also includes metric calculators 25-1 . . . 25-M configured to calculate respective metrics 27-1 . . . 27-M for the downlink measurement reports 32-1 . . . 32-M, as a function of the uplink-downlink reciprocity information 23. The metric 27-m for each downlink measurement report 32-m represents a relation between an uplink measurement on the serving cell 14S and an uplink measurement on the neighbor cell 14N, as determined from the downlink measurements reported by the downlink measurement report 32-m. In one embodiment, the relation is a difference in the logarithmic domain (dB) or a ratio in the linear domain. Regardless, as one example, metric calculator 25-1 calculates, as a function of the downlink measurements on the serving cell 14S and the neighbor cell 14N reported by downlink measurement report 32-1, and as a function of the uplink-downlink reciprocity information 23, a metric 27-1 representing a relation between an uplink measurement on the serving cell 14S and an uplink measurement on the neighbor cell 14N. Similarly, metric calculator 25-M calculates, as a function of the downlink measurements on the serving cell 14S and the neighbor cell 14N reported by downlink measurement report 32-N, and as a function of the uplink-downlink reciprocity information 23, a metric 27-M representing a relation between an uplink measurement on the serving cell 14S and an uplink measurement on the neighbor cell 14N.

The report selector 29 in some embodiments selects a downlink measurement report 32-m for inclusion in the subset 34 if the metric 27-m calculated for that downlink measurement report 32-m is less than a threshold 31. For example, where the metric 27-m calculated for downlink measurement report 32-m is represented as Mₘ and the threshold 31 is represented as TH, the report selector 29 in some embodiments selects the downlink measurement report 32-m for inclusion in the subset 34 if Mₘ≤TH. In one example, the threshold 31 may be defined by a user that configures the network node 30 to operate as described herein, e.g., as 5 dB.

Where the metric 27-m represents a difference or ratio between uplink measurements of the cells 14S, 14N, for example, the report selector 29 selects the downlink measurement report 32-m for inclusion in the subset 34 if that difference or ratio is less than the threshold 31. In one embodiment where the uplink measurements of the cells 14S, 14N are measurements of the uplink power received on the cells 14S, 14N, then, the report selector 29 selects the downlink measurement report 32-m for inclusion in the subset 34 if the difference or ratio between the uplink power received on the cells 14S, 14N is less than the threshold 31, e.g., indicating that uplink traffic 18 transmitted by the reporting communication device would be received on the serving cell 14S and the neighbor cell 14N with similar power. Indeed, in some embodiments, uplink traffic 18 on the serving cell 14S is assumed to interfere with uplink traffic 13 on the neighbor cell 14N in this case, e.g., such that the downlink measurement report 32-m reflects a snapshot or instance of uplink interference.

FIG. 4 shows that the report selector 29 implements downlink measurement report selection via report filters 29-1 . . . 29-M. Report filters 29-1 . . . 29-M filter respective ones the downlink measurement reports 32-1 . . . 32-M as a function of the metrics 27-1 . . . 27-M and the threshold 31. For example, report filter 29-1 filters downlink measurement report 32-1 if the metric 27-1 calculated for that downlink measurement report 32-1 is less than the threshold 31, but otherwise lets the downlink measurement report 32-1 pass through the report filter 29-1. Similarly, report filter 29-M filters downlink measurement report 32-M if the metric 27-M calculated for that downlink measurement report 32-M is less than the threshold 31, but otherwise lets the downlink measurement report 32-M pass through the report filter 29-M. Accordingly, downlink measurement reports 33 that pass through the report filters 29-1 . . . 29-M (i.e., non-filtered reports 33) are the reports effectively selected for inclusion in the subset 34.

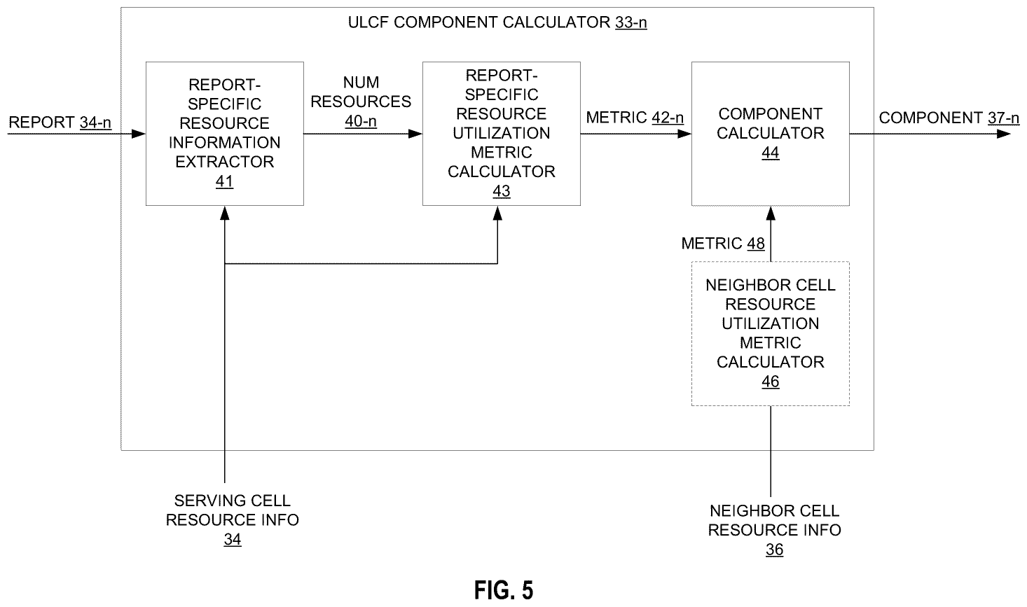

Consider next additional details of the ULCF component calculators 33-1 . . . 33-N, using an example in FIG. 5 of an ULCF component calculator 33-n that calculates an uplink coupling factor component 37-n for a downlink measurement report 34-n. The ULCF component calculator 33-n includes a report-specific resource information extractor 41. The report-specific resource information extractor 41 determines, as a function of the serving cell resource information 34, a number 40-n of transmission resources associated with the downlink measurement report 34-n. In some embodiments, the number 40-n of transmission resources associated with the downlink measurement report 34-n may be a number of transmission resources utilized, during a time period in which the downlink measurement report 34-n was reported, for uplink traffic 18 on the serving cell 14S by the communication device that reported the downlink measurement report 34-n. The number 40-n of transmission resources associated with the downlink measurement report 34-n may in some sense, then, be a number of transmission resources on the serving cell 14S that are associated with or attributable to the snapshot or instance of uplink interference reflected by the downlink measurement report 34-n.

In any event, the ULCF component calculator 33-n may thereafter calculate the uplink coupling factor component 37-n associated with the downlink measurement report 34-n as a function of this number 40-n of transmission resources associated with the downlink measurement report 34-n. As shown in FIG. 5, for example, the ULCF component calculator 33-n further includes a report-specific resource utilization metric calculator 43. The report-specific resource utilization metric calculator 43 calculates a report-specific resource utilization metric 42-n.

In some embodiments, the report-specific resource utilization metric calculator 43 calculates the report-specific resource utilization metric 42-n as a function of the number 40-n of transmission resources associated with the downlink measurement report 34-n. In one such embodiment, the report-specific resource utilization metric calculator 43 calculates the report-specific resource utilization metric 42-n as a ratio between the number 40-n of transmission resources associated with the downlink measurement report 34-n and the number of transmission resources available for uplink traffic 18 on the serving cell 14S. That is, the report-specific resource utilization metric calculator 43 may calculate the report-specific resource utilization metric 42-n for downlink measurement report 34-n as:

$${RUM}_{n} = \frac{{R}_{n}}{{AR}_{s}}$$

where RUMₙ is the report-specific resource utilization metric (RUM) 42-n, Rₙ is the number 40-n of transmission resources associated with the downlink measurement report 34-n, and ARₛ is the number of transmission resources available for uplink traffic 18 on the serving cell 14S. Here, the number of transmission resources available for uplink traffic 18 on the serving cell 14S may also be indicated by the serving cell resource information 34.

In any event, having calculated the report-specific resource utilization metric 42-n, the ULCF component calculator 33-n includes a component calculator 44 that calculates the uplink coupling factor component 37-n as a function of the report-specific resource utilization metric 42-n. In one embodiment, for example, the component calculator 44 calculates the uplink coupling factor component 37-n to be proportional to the report-specific resource utilization metric 42-n. Such proportionality may mean that an increase in the report-specific resource utilization metric 42-n results in a proportional increase to the uplink coupling factor component 37-n, and a decrease in the report-specific resource utilization metric 42-n results in a proportional decrease to the uplink coupling factor component 37-n.

FIG. 5 shows that, in some embodiments, the component calculator 44 calculates the uplink coupling factor component 37-n also as a function of the number of transmission resources utilized for uplink traffic 13 on the neighbor cell 14N (as indicated by the neighbor cell resource information 36). For instance, in the example of FIG. 5, the ULCF component calculator 33-n further includes a neighbor cell resource utilization metric calculator 46. The neighbor cell resource utilization metric calculator 46 calculates a neighbor cell resource utilization metric 48 as a function of the number of transmission resources available for uplink traffic 13 on the neighbor cell 14N and the number of transmission resources utilized for uplink traffic 13 on the neighbor cell 14N, as indicated by the neighbor cell resource information 36. The neighbor cell resource utilization metric calculator 46 may for example calculate the neighbor cell resource utilization metric 48 to be a ratio of the number of transmission resources utilized for uplink traffic 13 on the neighbor cell 14N to the number of transmission resources available for uplink traffic 13 on the neighbor cell 14N. That is, the neighbor cell resource utilization metric calculator 46 may calculate the neighbor cell resource utilization metric 48 as:

$$NRUM = \frac{{UR}_{N}}{{AR}_{N}}$$

where NRUM is the neighbor cell resource utilization metric 48, UR_{N} is the number of transmission resources utilized for uplink traffic 13 on the neighbor cell 14N, and AR_{N} is the number of transmission resources available for uplink traffic 13 on the neighbor cell 14N.

Regardless, the component calculator 44 calculates the uplink coupling factor component 37-n also as a function of this neighbor cell resource utilization metric 48. The component calculator 44 may for instance calculate the uplink coupling factor component 37-n to be proportional also to the neighbor cell resource utilization metric 48, e.g., such that the uplink coupling factor component 37-n is proportional to both the report-specific resource utilization metric 42-n and the neighbor cell resource utilization metric 48. As one example of this, the component calculator 44 may calculate the uplink coupling factor component 37-n for the downlink measurement report 34-n as:

$${ULCF}_{n} = {RUM}_{n} * NRUM$$

where ULCFₙ is the uplink coupling factor component 37-n for the downlink measurement report 34-n, RUMₙ is the report-specific resource utilization metric 42-n for the downlink measurement report 34-n, and NRUM is the neighbor cell resource utilization metric 48. In this case, across the measurement reports 34 in the subset, the ULCF calculator 40 may calculate the ULCF 37 as:

$$ULCF = {\sum }_{n = 1}^{N} {ULCF}_{n} = {\sum }_{n = 1}^{N} {RUM}_{n} * NRUM$$

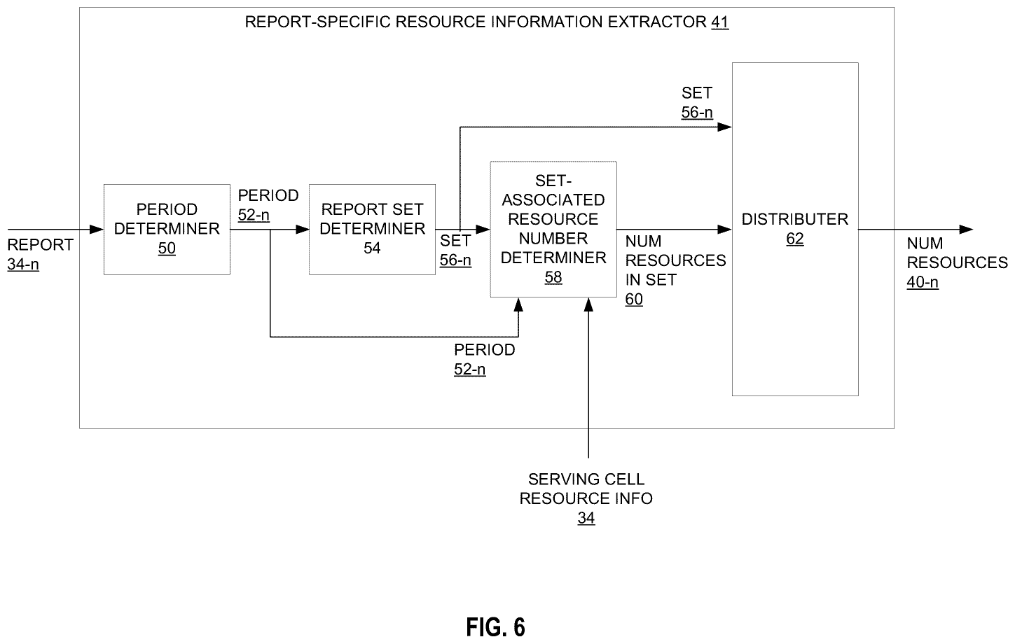

FIG. 6 now shows additional details of the report-specific resource information extractor 41 that determines the number 40-n of transmission resources associated with a downlink measurement report 34-n, according to some embodiments. In these embodiments, the serving cell resource information 34 indicates, for each of the communication devices 12 and for each of multiple resource information event periods, a number of transmission resources utilized by the communication device for uplink traffic 18 on the serving cell 14S during the resource information event period. Furthermore, the number of transmission resources available for uplink traffic 18 on the serving cell 14S is the number of transmission resources available for uplink traffic 18 on the serving cell 14S across the multiple resource information event periods.

In this context, as shown in FIG. 6, the report-specific resource information extractor 41 includes a period determiner 50 that determines, from among the multiple resource information event periods, a resource information event period 52-n within which the downlink measurement report 34-n was reported. A report set determiner 54 then determines a set 56-n of one or more downlink measurement reports 20 reported within the determined resource information event period 52-n. Downlink measurement report 34-n is included in this set 56-n.

A set-associated resource number determiner 58 determines a number 60 of transmission resources associated with this set 56-n as a function of the number of transmission resources utilized during the determined resource information event period 52-n for uplink traffic 18 on the serving cell 14S by the communication device which reported the downlink measurement report 34-n. A distributer 62 then equally distributes this number 60 of transmission resources associated with the set 56-n among the one or more downlink measurement reports included in the set 56-n, with each downlink measurement report included in the set 56-n being associated with the number of transmission resources distributed to that downlink measurement report. Accordingly, FIG. 6 shows that the report-specific resource information extractor 41 provides the number of 40-n of transmission resources associated with downlink measurement report 34-n as being the number of transmission resources distributed to that downlink measurement report 34-n by the distributor 62.

In some embodiments, the serving cell resource information 34 indicates the number of transmission resources utilized by each of the communication devices 12-1 . . . 12-X served by the serving cell 14S. In this case, then, the sum of the number of transmission resources utilized by each of the communication devices 12-1 . . . 12-X served by the serving cell 14S is equal to the number of transmission resources utilized for uplink traffic 18 on the serving cell 14S (across the communication devices 12-1 . . . 12-X).

In other embodiments, however, the serving cell resource information 34 indicates the number of transmission resources utilized by each of the communication devices in a subset of the communication devices 12-1 . . . 12-X served by the serving cell 14S. This may be the case for instance to control overhead required to obtain this information for all of the communication devices 12-1 . . . 12-X served by the serving cell 14S. In these embodiments, then, the serving cell resource information 34 may be extrapolated or normalized to reflect the entirety of the communication devices 12-1 . . . 12-X served by the serving cell 14S, not just the subset.

For example, in some embodiments, the set-associated resource number determiner 58 scales, by a scaling factor, the number of transmission resources utilized during the determined resource information event period 52-n for uplink traffic 18 on the serving cell 14S by the communication device which reported the downlink measurement report 34-n (as indicated by the serving cell resource information 34). The set-associated resource number determiner 58 then determines the number 60 of transmission resources associated with the set 56-n to be equal to this scaled number.

In one embodiment, for instance, the serving cell resource information 34 also indicates, for each of the multiple resource information event periods, a number of transmission resources utilized for uplink traffic 18 on the serving cell 14S collectively by communication devices 12-1 . . . 12-X served by the serving cell 14S during the resource information event period 52-n. In this case, the scaling factor may be a ratio of: (i) the number of transmission resources utilized for uplink traffic 18 on the serving cell 14S collectively by communication devices 12-1 . . . 12-X served by the serving cell 14S during the determined resource information event period 52-n; and (ii) a sum of the numbers of transmission resources respectively utilized by the communication devices for uplink traffic 18 on the serving cell 14S during the resource information event period 52-n.

Note that embodiments herein have been described for illustration purposes with respect to a particular serving cell 14S and a single neighbor cell 14N of the serving cell 14S. In some embodiments, though, the serving cell 14S may have multiple neighbor cells. In these embodiments, at least some of the downlink measurement reports 20-1 . . . 20-X may report downlink measurements for multiple neighbor cells. In this case, the embodiments above may be applied for each pairing of the serving cell 14S with respective ones of the neighbor cells.

Moreover, some embodiments herein have been described with respect to downlink measurement reports 32, serving cell resource information 34, and neighbor cell resource information 36 that are aligned in time and/or granularity. In some embodiments, though, the downlink measurement reports 32, the serving cell resource information 34, and/or the neighbor cell resource information 36 may be obtained from events, logs, traces, and/or records that occur or are made at times or with granularities that are different from that needed for the downlink measurement reports 32, the serving cell resource information 34, and/or the neighbor cell resource information 36. In this case, then, the network node 30 or some other node may process such events, logs, traces, and/or records in order to extract, generate, or derive the downlink measurement reports 32, the serving cell resource information 34, and/or the neighbor cell resource information 36, e.g., by correlating different events, logs, traces, and/or records in time and/or by aggregating some events, logs, traces, and/or records over time.

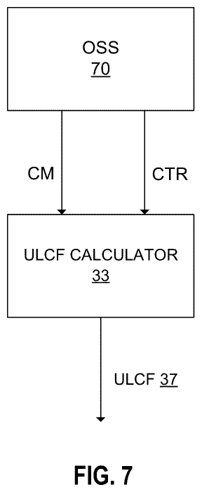

Consider an example implementation of these embodiments in a context where the downlink measurement reports 32, the serving cell resource information 34, and/or the neighbor cell resource information 36 are obtained from cell traffic recording (CTR) information, which is also known as call traces, call events, or call logs. In this example, the uplink coupling factor 37 is built as a highly accurate measure of the coupling in the uplink direction between cells (i.e., a measure of how the uplink traffic in one cell interferes the uplink traffic in another cell), making use of performance events in the communication network 10, which are based on measurements collected through CTR. This CTR information, together with some Configuration Management (CM) parameters, is available in the Operations Support System (OSS) in this example. As shown in FIG. 7, the network node 30 herein may read the CTR information and CM parameters, as needed, from the OSS 70 and then process the read CTR information and CM parameters to calculate the uplink coupling factor 37 between different cells.

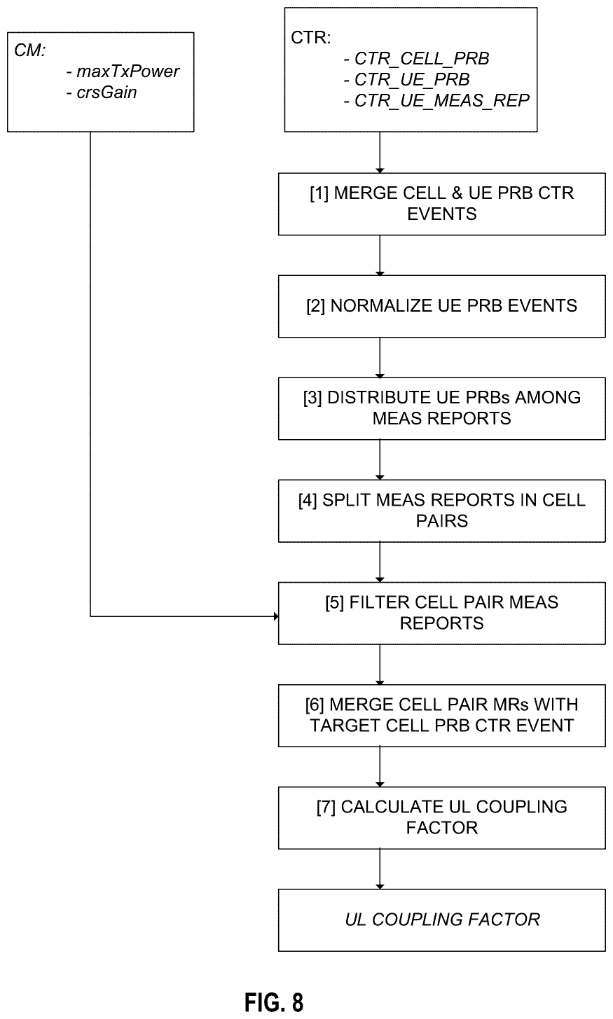

FIG. 8 illustrates additional details for calculating the uplink coupling factor 37 between cells according to some embodiments based on the CTR information and the CM parameters. The names for the CM parameters and CTR events are generic, however, just for contextualization, the specific example for Ericsson Long Term Evolution (LTE) is provided, with its exact names. These embodiments could be implemented for NR as well as for other vendors different from Ericsson. Here, physical resource blocks (PRBs) exemplify transmission resources.

In this example, the network node 30 reads from the OSS 70 CM parameters that include maxTxPower and crsGain. maxTxPower defines the maximum transmission power in dBm in the cell. In Ericsson LTE, this parameter is called maximumTransmissionPower. crsGain defines the power offset in dB to be applied to the cell reference signal resource element with respect to the rest of resource elements. In Ericsson LTE, this parameter is called crsGain.

Further in this example, the network node 30 reads from the OSS 70 CTR information that includes CTR_CELL_PRB, CTR_UE_PRB, and CTR_UE_MEAS_REP. CTR_CELL_PRB contains information about the total number of available and used physical resource blocks (PRBs) per cell, during a time interval, typically around one minute. This event in Ericsson LTE is called INTERNAL_PER_RADIO_UTILIZATION. CTR_UE_PRB contains information about the number of used PRBs per user equipment (UE), during a time interval, typically around one second. This event in Ericsson LTE is called INTERNAL_PER_UE_TRAFFIC_REP. CTR_UE_MEAS_REP contains information about a single measurement report sent by the UE. The measurement report provides the Reference Signal Received Power (RSRP) of the serving cell as well as the RSRP of all the intra-frequency cells detected by the UE. The detected cells are identified by the Physical Cell ID (PCI), so the network node 30 or some other node may implement an algorithm in order to define univocally the detected cells. Every measurement report corresponds to a certain timestamp, and they are sent periodically, typically between 5 and 10 seconds. In Ericsson LTE this event is called UE_MEAS_INTRAFREQ1/2.

As shown in FIG. 8, a first step is to merge cell and UE PRB CTR events. In this step, the time period of the cell and UE PRB events are consolidated. Typically, the time period of the UE event is much smaller than the time period of the cell event, so an aggregation is done here to sum (mathematically) the UE events per UE and per cell time period. This is the UE PRB event that will be used from now onwards. In some embodiments herein, the duration of the UE PRB event corresponds to the time period of the cell event. This time period may be one example of a so-called resource information event period in some embodiments herein.

In a second step, the network node 30 normalizes UE PRB events. In this regard, UE events are quite demanding in terms of transfer bandwidth and storage size. Due to this reason, in many cases, not all the UEs are recorded in the per UE events, only a certain sample of UEs. In this case, the number of used PRBs reported in the cell event will not match the sum of the number of used PRBs reported in the UE events. Therefore, in this example, the number of PRBs in the UE event are normalized multiplying it by the following term:

$$\frac{\# USED PRB CELL EVENT}{{\sum }_{∀ UE} \#USED PRB UE EVENT} ,$$

This term is one example of a so-called scaling factor in some embodiments herein. In this case, #USED PRB CELL EVENT is one example of the number of transmission resources utilized for uplink traffic 18 on the serving cell 14S collectively by communication devices 12-1 . . . 12-X served by the serving cell 14S during a resource information event period, e.g., UE PRB event. And Σ_{∀UE} #USED PRB UE EVENT is one example of a sum of the numbers of transmission resources respectively utilized by the communication devices 12-1 . . . 12-X for uplink traffic 18 on the serving cell 14S during the resource information event period.

In a third step, the network node 30 distributes UE PRBs among measurement reports. UE measurement reports will be associated with its corresponding UE PRB event, by means of the serving cell and the timestamp of the measurement report. Typically, more than one measurement report will fall in the same UE PRB event. After that, the number of PRBs in a single UE PRB event will be split equally among all the associated measurement reports. Here, all the measurement reports associated with a UE PRB event exemplify the set of one or more downlink measurement reports reported within a resource information event period.

In a fourth step, the network node 30 splits measurement reports in cell pairs. The first cell in a measurement report will be always the serving cell, and the second cell will be one the neighbor cells. There will be as many pairs as number of reported neighbor cells. The number of PRBs associated to the measurement report will be stored in every cell pair. Note that there can be measurement reports without any neighboring cell, only with the serving cell; in that case this measurement report is ignored, and no cell pair will be generated.

In a fifth step, the network node 30 filters cell pair measurement reports, e.g., as an example of report selection performed by report selector 29 in FIG. 2. In this example, only the cell pair measurement reports which can generate relevant UL interference must remain. UL interference is assumed to happen when the UL power received by the serving cell (desired signal) is similar to the UL received power in the neighbor cell (interfering signal). For this reason, a filtering phase is introduced here. The measurement reports contain the received power of the reference signal in the downlink (DL) direction, so it is necessary to translate this power to the data channel in the UL direction. For this purpose, the maximum transmission power and the cell reference signal offset of the cell are used, and channel reciprocity (UL pathloss is the same as DL pathloss) is assumed. Thus, the filtering criterion to consider the cell pair measurement report is expressed in this example as follows:

$${RSRP}_{serving} - {RSRP}_{neigh} - ( {maxTxPower}_{source} + {crsGain}_{source} - {maxTxPower}_{neigh} - {crsGain}_{neigh} ) \leq threshold ( defined by user , eg : 5 dB ) ,$$

The term to the left of the inequality exemplifies a metric representing a relation between an uplink measurement on the serving cell and an uplink measurement on a neighbor cell, according to some embodiments herein.

In a sixth step, the network node 30 merges cell pair measurement reports with neighbor cell PRB CTR event. Every measurement report cell pair will be merged with a cell PRB event based on the neighbor cell and timestamp.

In a seventh step, the network node 30 calculates the UL coupling factor 37. In this example, the network node calculates the UL coupling factor 37 between two cells considering all the filtered cell pair measurement reports involving both cells and applying the formula below:

$$UL Coupling Factor = {\sum }_{∀ meas report} ( serving user util ) * ( neighbor cell util ) ,$$

The serving user utilization for a cell pair measurement report is calculated as the ratio between the number of PRBs used by the user specific measurement report and the sum of all the available PRBs in the serving cell in the whole measurement period, i.e.:

$$serving user util = \frac{\#used PRB meas report}{{\sum }_{∀ serving cell event} \#avail PRB} ,$$

The neighbor cell utilization for a cell pair measurement report is calculated as the ratio between the total number of used (by any user) PRBs in the neighbor cell and the number of available PRBs in the neighbor cell, calculated using the neighbor cell event associated to the cell pair measurement report, i.e.:

$$neighbor cell util = \frac{\#used PRB neighbor cell event}{\#avail PRB neighbor cell event} ,$$

In this example, then, the term (serving user util)*(neighbor cell util) represents one example of an uplink coupling factor component 37-n associated with a downlink measurement report 32-n herein. The term serving user util represents an example of a report-specific resource utilization metric 42-n and the term neighbor cell util represents an example of a neighbor cell resource utilization metric 48 in FIG. 5. Correspondingly, #used PRB meas report represents an example of the number of transmission resources associated with a downlink measurement report, and Σ_{∀serving cell event} #avail PRB represents an example of the number of transmission resources available for uplink traffic on the serving cell.

At the point before applying this formula for the uplink coupling factor 37, there may be tens or thousands of pair measurements which relate a certain serving cell with a certain interfered (neighbor) cell. The embodiments herein, by way of this formula, aggregate all these measurements to extract a single value which represents the UL coupling factor 37 between the serving cell 14S and the neighbor cell 14N. The quantity used for the aggregation is the product between the user PRB utilization in the serving cell and the cell PRB utilization in the neighbor cell. This way, a user with higher PRB utilization in the serving cell will interfere more and therefore will increment more the UL coupling factor 37. On the other hand, a neighbor (interfered) cell with higher PRB utilization will be impacted more by the interference and therefore will increment more the UL coupling factor 37.

Note that this uplink coupling factor 37 in this example is not symmetric. That is, the value from cell A to cell B is different from the value from cell B to cell A. Or in other words, the way in which the UL traffic in cell A interferes the UL traffic in the cell B is different from the way in which the UL traffic in cell B interferes the UL traffic in cell A.

Note further that, in order to determine the UL coupling factor 37, it is necessary to know the power at which a communication device is reaching the serving cell, but also the power at which the communication device is reaching all the interfered cells. For the serving part, this is already known by the serving cell because it is serving the communication device. However, the interfered cells will see this as pure interference and cannot distinguish and extract useful info from this. For that reason, some embodiments herein use the measurement reports, in which the communication device measures the DL received power not only from the serving base station but also from all the interfered ones at the same time. Using the reciprocity calculation, some embodiments estimate the UL power for all the involved cells.

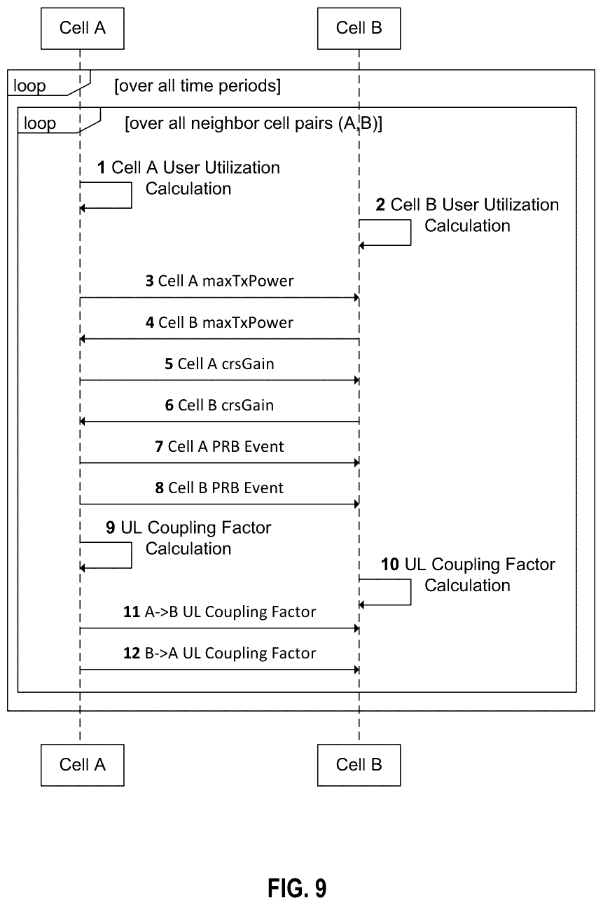

In some embodiments, the uplink coupling factor 37 is calculated in a centralized manner, e.g., where network node 30 calculates the uplink coupling factor 37 for multiple serving cells. In other embodiments, though, the uplink coupling factor 37 is calculated in a distributed manner, in which the calculation is carried out in the involved nodes by means of the information exchanged between them. FIG. 9 shows one example.

In the sequence diagram of FIG. 9, cells A and B are located in different nodes, since otherwise the information exchange between them will be not needed.

Messages 1 and 2 correspond with the calculation steps 1-4 in the flowchart shown in FIG. 8. Messages 9 and 10 correspond with the calculation steps 5-7 in the same flowchart.

Related to the information exchanged between the cells, messages 3-6 are cell CM parameters which do not change very often. Messages 7-8 are cell event indicators sent every time period, depending on the vendor granularity to generate those events, typically one minute. Messages 11-12 are neighbor level indicators, calculated and sent every time period, typically one minute.

Given the above, the amount of information exchanged between the cells is estimated to be low, just a few bytes per minute. All the UE level correlation and calculation are performed in the nodes in a distributed manner.

This information can be exchanged by means of the X2 interface in case of LTE, or the Xn interface in case of NR, by implementing a vendor proprietary extension.

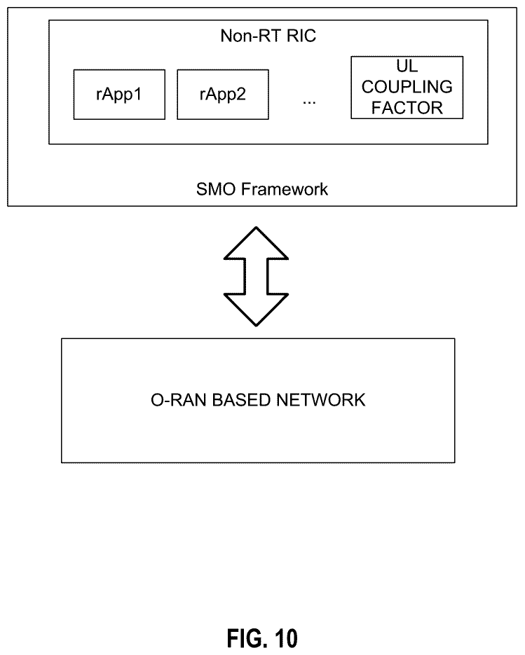

Note, too, that some embodiments can be implemented as a single rApp in the Non Real-Time Radio Access Network Intelligent Controller (Non-RT RIC) located in the Service Management & Orchestrator (SMO) Framework of the Open Radio Access Network (O-RAN) architecture. This is shown in FIG. 10.

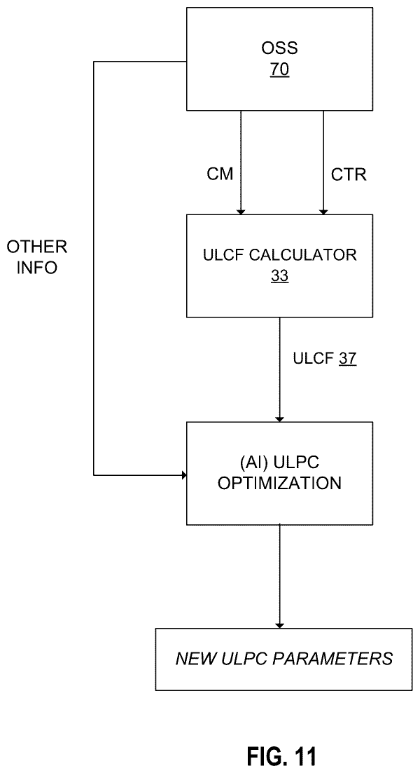

In any event, in some embodiments, the uplink coupling factor 37 is used as input for any optimization algorithm which manages the uplink power control (ULPC) parameters. The optimization algorithm may for example be based on artificial intelligence or machine learning. No matter the type of algorithm though, the UPLC optimization may produce new ULPC parameters for uplink power control, as shown in FIG. 11.

In embodiments that exploit the uplink coupling factor 37 for an ULPC optimization algorithm based on AI or machine learning, the UL coupling factor 37 may be one of the input features for the AI model or machine learning model. One example of an AI architectures that can be used for the ULPC optimization is an agent based in Reinforcement Learning (RL) like the one described in WO2021190772A1. In this case the UL coupling factor 37 can be used for, considering all the cell relations between the source cell and any target cell, calculating a single value (by means of any mathematical function) using all the factors from all the cell relations and use this value as input feature for the source cell. Or, the uplink coupling factor 37 can be used for, considering all the cell relations between any source cell and the target cell, calculating a single value (by means of any mathematical function) using all the factors from all the cell relations and use this value as input feature for the target cell. Or, the uplink coupling factor 37 can be used for creating new features in the source cell, representing the weighted average of features from other cells, and using this coupling factor as weight.

Another example of an AI architecture that can be used for the ULPC optimization is a model based in a Graph Neural Network (GNN). In this case, the uplink coupling factor 37 fits the architecture since it can be used as an edge feature or fill directly the adjacency matrix of the graph.

Note that although the uplink coupling factor 37 can used for ULPC optimization, its usage is not restricted uniquely to that purpose. For instance, the uplink coupling factor 37 can be used for troubleshooting or for just monitoring the cells which are impacting the most on other cells in the UL.

Note also that some embodiments herein may be applied for ULPC in LTE or NR networks. In LTE and NR in this regard, ULPC is used to adjust the power transmitted by the user terminal to adapt to: a) radio propagation channel conditions, including pathloss, shadowing and fast fading, and b) interference from other users served by surrounding cells. Thus, network performance is improved in terms of retainability (i.e., dropped connection rate) and minimum/average/peak user throughput.

3rd Generation Partnership Project (3GPP) standards specify the ULPC scheme for Physical Uplink Shared Channel (PUSCH) in LTE and NR. Such a scheme is based on the combination of two mechanisms, namely open-loop and closed-loop operation. The basic open-loop operating point is defined as

$${P}_{{TX}_{open - loop}} = {P}_{0} + α \cdot PL [ \frac{dBm}{PRB} ] ,$$

where P_{TX}_{ₒₚₑₙ₋ₗₒₒₚ} is the UE transmit power in a single Physical Resource Block (PRB) whose objective is to compensate for slow channel variations. P₀ defines the average received power density target level for all User Equipments (UEs) in a cell, PL are the propagation losses and a is the channel pathloss compensation factor. In parallel, the closed-loop operation is added to adapt UE to changes in the inter-cell interference, fast fading and/or measurement and power amplifier errors. The closed-loop operation is defined as

$$Dynamic {offset}_{closed - loop} = {Δ}_{TF} + f ( {Δ}_{TPC} ) [ dB ] ,$$

where Dynamic offset_{closed-loop} is an additional power gain term to add to P_{TX}_{ₒₚₑₙ₋ₗₒₒₚ}. Its value depends on the selected modulation scheme (Δ_{TF}) and power-control commands sent by the eNodeB or gNodeB (Δ_{TPC}) according to function ƒ(⋅).

Thus, the power control scheme for the Physical Uplink Shared Channel (PUSCH) including open-loop and closed-loop mechanisms calculates the UE transmit power (P_{TX}) in each subframe (1 ms in LTE and 1 ms or less in NR) as

$${P}_{TX} = min \{ {P}_{{tx}_{max}} , {\underbrace{{P}_{0} + α \cdot PL}}_{\begin{matrix}basic open - loop \\ operating point\end{matrix}} + {\underbrace{{Δ}_{TF} + f ( {Δ}_{TPC} )}}_{dynamic offset} + {\underbrace{10 \cdot {log}_{10} {M}_{PUSCH}}}_{bandwidth factor} \} [ dBm ] ,$$

where Pₜₓ_{ₘₐₓ} is the maximum UE transmit power and M_{PUSCH} is the number of allocated PRBs to the UE.

ULPC is considered to be quite complex, because modifying a parameter in a single cell not only affects that cell, but also affects all its neighboring cells. For example, increasing the P₀ parameter in a cell will improve the performance of the users in that cell, but will increase the interference in the neighboring cells, negatively impacting their performance. Some embodiments herein thereby adapt this P₀ parameter based on the ULCF 37 herein.

Note that, as used herein, a cell may correspond to a carrier frequency or component carrier.

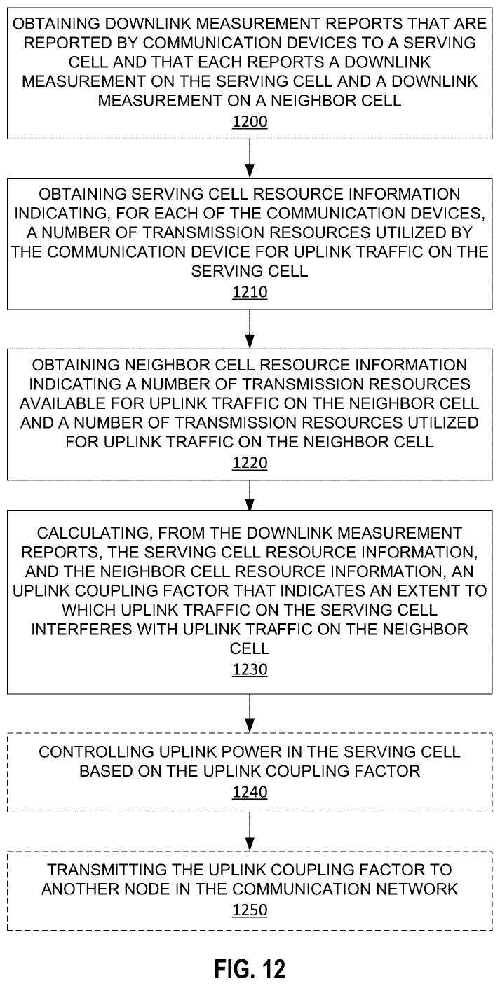

In view of the modifications and variations herein, FIG. 12 depicts a method performed by a network node 30 configured for use in a communication network 10 in accordance with particular embodiments. The method includes obtaining downlink measurement reports 32 that are reported by communication devices 12-1 . . . 12-X to a serving cell 14S and that each reports a downlink measurement on the serving cell 14S and a downlink measurement on a neighbor cell 14N (Block 1200). The method also includes obtaining serving cell resource information 34 indicating, for each of the communication devices 12-1 . . . 12-X, a number of transmission resources utilized by the communication device for uplink traffic 18 on the serving cell 14S (Block 1210). The method also includes obtaining neighbor cell resource information 36 indicating a number of transmission resources available for uplink traffic 13 on the neighbor cell 14N and a number of transmission resources utilized for uplink traffic 13 on the neighbor cell 14N (Block 1220). The method further includes calculating, from the downlink measurement reports 32, the serving cell resource information 34, and the neighbor cell resource information 36, an uplink coupling factor (ULCF) 37 that indicates an extent to which uplink traffic 18 on the serving cell 14S interferes with uplink traffic 13 on the neighbor cell 14N (Block 1230).

In some embodiments, the method includes controlling uplink power in the serving cell 14S based on the uplink coupling factor 37 (Block 1240). Alternatively or additionally, the method includes transmitting the uplink coupling factor 37 to another node in the communication network 10 (Block 1250).

In some embodiments, calculating the uplink coupling factor 37 comprises selecting, from the downlink measurement reports 32, a subset of downlink measurement reports 32 that, assuming downlink-uplink reciprocity, each indicate uplink traffic 18 on the serving cell 14S interferes with uplink traffic 13 on the neighbor cell 14N. Calculating the uplink coupling factor 37 also comprises, for each downlink measurement report in the subset, calculating, as a function of the serving cell resource information 34 and the neighbor cell resource information 36, an uplink coupling factor component associated with the downlink measurement report. Calculating the uplink coupling factor 37 further comprises calculating the uplink coupling factor 37 as a function of the uplink coupling factor components 37-1 . . . 37-N.

In one or more of these embodiments, calculating the uplink coupling factor component for each downlink measurement report in the subset comprises, for each downlink measurement report in the subset, determining, as a function of the serving cell resource information 34, a number of transmission resources associated with the downlink measurement report. Calculating the uplink coupling factor component for each downlink measurement report in the subset also comprises, for each downlink measurement report in the subset, calculating the uplink coupling factor component associated with the downlink measurement report as a function of the number of transmission resources associated with the downlink measurement report. For example, in some embodiments, calculating the uplink coupling factor component for each downlink measurement report in the subset comprises, for each downlink measurement report in the subset, calculating a report-specific resource utilization metric as a function of the number of transmission resources associated with the downlink measurement report, and calculating the uplink coupling factor component associated with the downlink measurement report as a function of the report-specific resource utilization metric. In one such embodiment, where the serving cell resource information 34 also indicates a number of transmission resources available for uplink traffic 18 on the serving cell 14S, the report-specific resource utilization metric calculated for a downlink measurement report in the subset is a ratio between the number of transmission resources associated with the downlink measurement report and the number of transmission resources available for uplink traffic 18 on the serving cell 14S.

In some embodiments, the serving cell resource information 34 indicates, for each of the communication devices 12-1 . . . 12-X and for each of multiple resource information event periods, a number of transmission resources utilized by the communication device for uplink traffic 18 on the serving cell 14S during the resource information event period. And, the number of transmission resources available for uplink traffic 18 on the serving cell 14S is the number of transmission resources available for uplink traffic 18 on the serving cell 14S across the multiple resource information event periods. In one such embodiment, for each downlink measurement report in the subset, determining the number of transmission resources associated with the downlink measurement report comprises (i) determining, from among the multiple resource information event periods, a resource information event period within which the downlink measurement report was reported; (ii) determining a set of one or more downlink measurement reports 32 reported within the determined resource information event period; (iii) determining a number of transmission resources associated with the set as a function of the number of transmission resources utilized during the determined resource information event period for uplink traffic 18 on the serving cell 14S by the communication device which reported the downlink measurement report; and (iv) equally distributing the number of transmission resources associated with the set among the one or more downlink measurement reports 32 included in the set, with each downlink measurement report included in the set being associated with the number of transmission resources distributed to that downlink measurement report. In one or more of these embodiments, determining the number of transmission resources associated with the set comprises (i) scaling, by a scaling factor, the number of transmission resources utilized during the determined resource information event period for uplink traffic 18 on the serving cell 14S by the communication device which reported the downlink measurement report; and (ii) determining the number of transmission resources associated with the set to be equal to the scaled number. For example, in embodiments where the serving cell resource information 34 also indicates, for each of the multiple resource information event periods, a number of transmission resources utilized for uplink traffic 18 on the serving cell 14S collectively by communication devices 12-1 . . . 12-X served by the serving cell 14S during the resource information event period, the scaling factor may be a ratio of (i) the number of transmission resources utilized for uplink traffic 18 on the serving cell 14S collectively by communication devices 12-1 . . . 12-X served by the serving cell 14S during the determined resource information event period; and (ii) a sum of the numbers of transmission resources respectively utilized by the communication devices 12-1 . . . 12-X for uplink traffic 18 on the serving cell 14S during the resource information event period.

In some embodiments, calculating the uplink coupling factor component associated with the downlink measurement report as a function of the report-specific resource utilization metric comprises calculating the uplink coupling factor component associated with the downlink measurement report to be proportional to the report-specific resource utilization metric.

In some embodiments, calculating the uplink coupling factor component for each downlink measurement report in the subset comprises, for each downlink measurement report in the subset, calculating the uplink coupling factor component associated with the downlink measurement report also as a function of the number of transmission resources utilized for uplink traffic 13 on the neighbor cell 14N. In one or more of these embodiments, calculating the uplink coupling factor component for each downlink measurement report in the subset comprises, for each downlink measurement report in the subset calculating a neighbor cell resource utilization metric as a function of the number of transmission resources available for uplink traffic 13 on the neighbor cell 14N and the number of transmission resources utilized for uplink traffic 13 on the neighbor cell 14N, and calculating the uplink coupling factor component associated with the downlink measurement report as a function of the neighbor cell resource utilization metric. In one or more of these embodiments, the neighbor cell resource utilization metric is a ratio of the number of transmission resources utilized for uplink traffic 13 on the neighbor cell 14N to the number of transmission resources available for uplink traffic 13 on the neighbor cell 14N. In one or more of these embodiments, calculating the uplink coupling factor component associated with the downlink measurement report as a function of the neighbor cell resource utilization metric comprises calculating the uplink coupling factor component associated with the downlink measurement report to be proportional to the neighbor cell resource utilization metric.

In some embodiments, calculating the uplink coupling factor 37 as a function of the uplink coupling factor components 37-1 . . . 37-N comprises calculating the uplink coupling factor 37 as a sum of the uplink coupling factor components 37-1 . . . 37-N.

In some embodiments, selecting the subset of downlink measurement reports 32 comprises, for each of the downlink measurement reports 32, (i) calculating, as a function of the downlink measurements on the serving cell 14S and the neighbor cell 14N reported by the downlink measurement report, and as a function of uplink-downlink reciprocity information, a metric representing a relation between an uplink measurement on the serving cell 14S and an uplink measurement on the neighbor cell 14N; and (ii) selecting the downlink measurement report for inclusion in the subset if the metric is less than a threshold. In one or more of these embodiments, the relation is a ratio in a linear domain. In some embodiments, the uplink-downlink reciprocity information includes a maximum transmission power on the serving cell 14S and a power offset between power to be applied to transmission resources carrying a reference signal measured by downlink measurements on the serving cell 14S and power to be applied to transmission resources not carrying the reference signal.

In some embodiments, the method further comprises controlling uplink power in the serving cell 14S based on the uplink coupling factor 37. In one or more of these embodiments, said controlling comprises generating a model of uplink power in the serving cell 14S using the uplink coupling factor 37 and controlling uplink power in the serving cell 14S based on the model.

In some embodiments, the method further comprises transmitting the uplink coupling factor 37 to another node in the communication network.

In some embodiments, the serving cell resource information 34 indicates, for each of the communication devices 12-1 . . . 12-X and for each of multiple resource information event periods, a number of transmission resources utilized by the communication device for uplink traffic 18 on the serving cell 14S during the resource information event period. In some embodiments, obtaining the serving cell resource information 34 comprises obtaining device resource information indicating, for each of the communication devices 12-1 . . . 12-X and for each of multiple device information event periods, a number of transmission resources utilized by the communication device for uplink traffic 18 on the serving cell 14S during the device information event period. Obtaining the serving cell resource information 34 in this case comprises obtaining the serving cell resource information 34 by, for each of the communication devices 12-1 . . . 12-X and for each of the multiple resource information event periods, (i) determining a set of device information event periods for the communication device that occur during the resource information event period; and (ii) calculating the number of transmission resources utilized by the communication device for uplink traffic 18 on the serving cell 14S during the resource information event period by aggregating the numbers of the transmission resources utilized by the communication device for uplink traffic 18 on the serving cell 14S during the respective device information event periods in the determined set. In one embodiment, for example, the serving cell resource information 34 also indicates, for each of the multiple resource information event periods, a number of transmission resources utilized for uplink traffic 18 on the serving cell 14S collectively by communication devices 12-1 . . . 12-X served by the serving cell 14S during the resource information event period.

Embodiments herein also include corresponding apparatuses. Embodiments herein for instance include a network node 30 configured to perform any of the steps of any of the embodiments described above for the network node 30.

Embodiments also include a network node 30 comprising processing circuitry and power supply circuitry. The processing circuitry is configured to perform any of the steps of any of the embodiments described above for the network node 30. The power supply circuitry is configured to supply power to the network node 30.

Embodiments further include a network node 30 comprising processing circuitry. The processing circuitry is configured to perform any of the steps of any of the embodiments described above for the network node 30. In some embodiments, the network node 30 further comprises communication circuitry.

Embodiments further include a network node 30 comprising processing circuitry and memory. The memory contains instructions executable by the processing circuitry whereby the network node 30 is configured to perform any of the steps of any of the embodiments described above for the network node 30.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

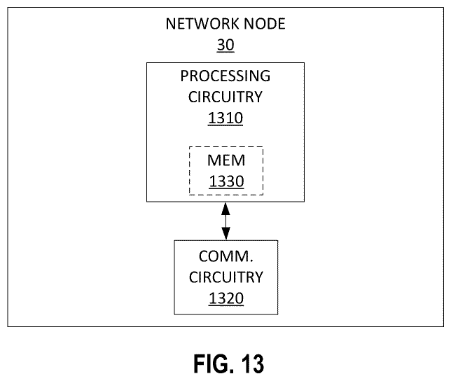

FIG. 13 illustrates a network node 30 as implemented in accordance with one or more embodiments. As shown, the network node 30 includes processing circuitry 1310 and communication circuitry 1320. The communication circuitry 1320 is configured to transmit and/or receive information to and/or from one or more other nodes, e.g., via any communication technology. The processing circuitry 1310 is configured to perform processing described above, e.g., in FIG. 12, such as by executing instructions stored in memory 1330. The processing circuitry 1310 in this regard may implement certain functional means, units, or modules.

Those skilled in the art will also appreciate that embodiments herein further include corresponding computer programs.

A computer program comprises instructions which, when executed on at least one processor of a network node 30, cause the network node 30 to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of a network node 30, cause the network node 30 to perform as described above.

Embodiments further include a computer program product comprising program code portions for performing the steps of any of the embodiments herein when the computer program product is executed by a network node 30. This computer program product may be stored on a computer readable recording medium.

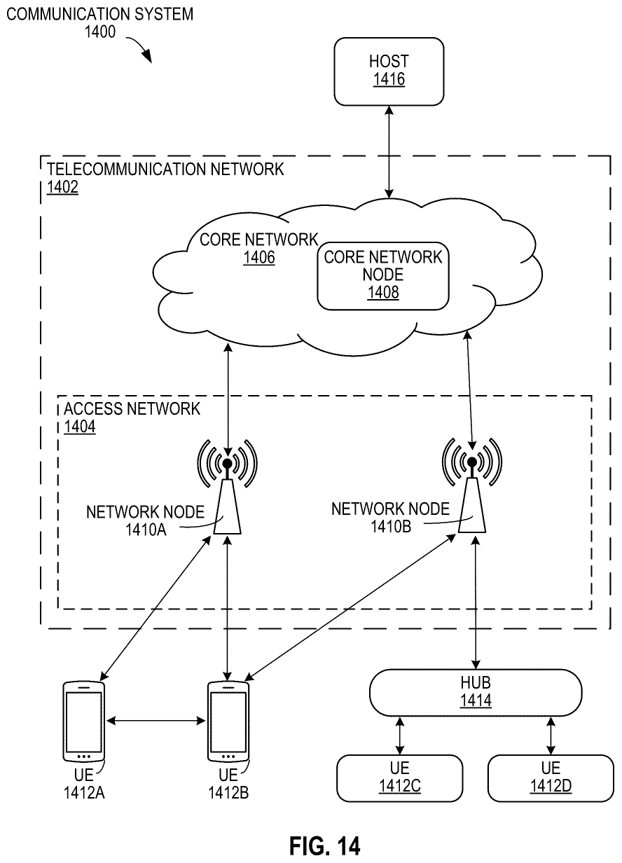

FIG. 14 shows an example of a communication system 1400 in accordance with some embodiments.

In the example, the communication system 1400 includes a telecommunication network 1402 that includes an access network 1404, such as a radio access network (RAN), and a core network 1406, which includes one or more core network nodes 1408. The access network 1404 includes one or more access network nodes, such as network nodes 1410a and 1410b (one or more of which may be generally referred to as network nodes 1410), or any other similar 3^{rd} Generation Partnership Project (3GPP) access node or non-3GPP access point. The network nodes 1410 facilitate direct or indirect connection of user equipment (UE), such as by connecting UEs 1412a, 1412b, 1412c, and 1412d (one or more of which may be generally referred to as UEs 1412) to the core network 1406 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1400 may include any number of wired or wireless networks, network nodes, UEs, and/or any other components or systems that may facilitate or participate in the communication of data and/or signals whether via wired or wireless connections. The communication system 1400 may include and/or interface with any type of communication, telecommunication, data, cellular, radio network, and/or other similar type of system.

The UEs 1412 may be any of a wide variety of communication devices, including wireless devices arranged, configured, and/or operable to communicate wirelessly with the network nodes 1410 and other communication devices. Similarly, the network nodes 1410 are arranged, capable, configured, and/or operable to communicate directly or indirectly with the UEs 1412 and/or with other network nodes or equipment in the telecommunication network 1402 to enable and/or provide network access, such as wireless network access, and/or to perform other functions, such as administration in the telecommunication network 1402.

In the depicted example, the core network 1406 connects the network nodes 1410 to one or more hosts, such as host 1416. These connections may be direct or indirect via one or more intermediary networks or devices. In other examples, network nodes may be directly coupled to hosts. The core network 1406 includes one more core network nodes (e.g., core network node 1408) that are structured with hardware and software components. Features of these components may be substantially similar to those described with respect to the UEs, network nodes, and/or hosts, such that the descriptions thereof are generally applicable to the corresponding components of the core network node 1408. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1416 may be under the ownership or control of a service provider other than an operator or provider of the access network 1404 and/or the telecommunication network 1402, and may be operated by the service provider or on behalf of the service provider. The host 1416 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1400 of FIG. 14 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1402 is a cellular network that implements 3GPP standardized features. Accordingly, the telecommunications network 1402 may support network slicing to provide different logical networks to different devices that are connected to the telecommunication network 1402. For example, the telecommunications network 1402 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1412 are configured to transmit and/or receive information without direct human interaction. For instance, a UE may be designed to transmit information to the access network 1404 on a predetermined schedule, when triggered by an internal or external event, or in response to requests from the access network 1404. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1414 communicates with the access network 1404 to facilitate indirect communication between one or more UEs (e.g., UE 1412c and/or 1412d) and network nodes (e.g., network node 1410b). In some examples, the hub 1414 may be a controller, router, content source and analytics, or any of the other communication devices described herein regarding UEs. For example, the hub 1414 may be a broadband router enabling access to the core network 1406 for the UEs. As another example, the hub 1414 may be a controller that sends commands or instructions to one or more actuators in the UEs. Commands or instructions may be received from the UEs, network nodes 1410, or by executable code, script, process, or other instructions in the hub 1414. As another example, the hub 1414 may be a data collector that acts as temporary storage for UE data and, in some embodiments, may perform analysis or other processing of the data. As another example, the hub 1414 may be a content source. For example, for a UE that is a VR headset, display, loudspeaker or other media delivery device, the hub 1414 may retrieve VR assets, video, audio, or other media or data related to sensory information via a network node, which the hub 1414 then provides to the UE either directly, after performing local processing, and/or after adding additional local content. In still another example, the hub 1414 acts as a proxy server or orchestrator for the UEs, in particular in if one or more of the UEs are low energy IoT devices.

The hub 1414 may have a constant/persistent or intermittent connection to the network node 1410b. The hub 1414 may also allow for a different communication scheme and/or schedule between the hub 1414 and UEs (e.g., UE 1412c and/or 1412d), and between the hub 1414 and the core network 1406. In other examples, the hub 1414 is connected to the core network 1406 and/or one or more UEs via a wired connection. Moreover, the hub 1414 may be configured to connect to an M2M service provider over the access network 1404 and/or to another UE over a direct connection. In some scenarios, UEs may establish a wireless connection with the network nodes 1410 while still connected via the hub 1414 via a wired or wireless connection. In some embodiments, the hub 1414 may be a dedicated hub—that is, a hub whose primary function is to route communications to/from the UEs from/to the network node 1410b. In other embodiments, the hub 1414 may be a non-dedicated hub—that is, a device which is capable of operating to route communications between the UEs and network node 1410b, but which is additionally capable of operating as a communication start and/or end point for certain data channels.

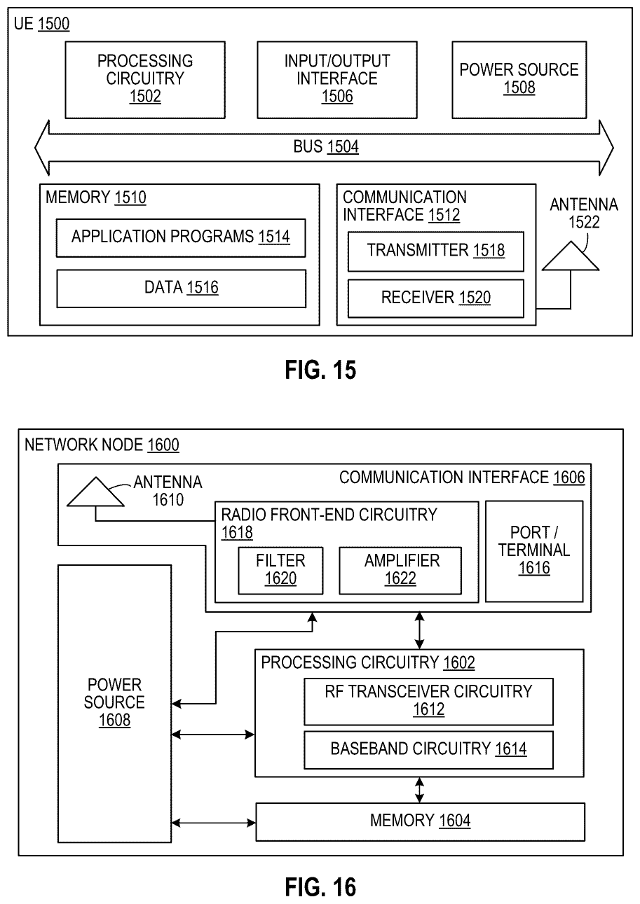

FIG. 15 shows a UE 1500 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1500 includes processing circuitry 1502 that is operatively coupled via a bus 1504 to an input/output interface 1506, a power source 1508, a memory 1510, a communication interface 1512, and/or any other component, or any combination thereof. Certain UEs may utilize all or a subset of the components shown in FIG. 15. The level of integration between the components may vary from one UE to another UE. Further, certain UEs may contain multiple instances of a component, such as multiple processors, memories, transceivers, transmitters, receivers, etc.

The processing circuitry 1502 is configured to process instructions and data and may be configured to implement any sequential state machine operative to execute instructions stored as machine-readable computer programs in the memory 1510. The processing circuitry 1502 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1502 may include multiple central processing units (CPUs).

In the example, the input/output interface 1506 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1500. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1508 is structured as a battery or battery pack. Other types of power sources, such as an external power source (e.g., an electricity outlet), photovoltaic device, or power cell, may be used. The power source 1508 may further include power circuitry for delivering power from the power source 1508 itself, and/or an external power source, to the various parts of the UE 1500 via input circuitry or an interface such as an electrical power cable. Delivering power may be, for example, for charging of the power source 1508. Power circuitry may perform any formatting, converting, or other modification to the power from the power source 1508 to make the power suitable for the respective components of the UE 1500 to which power is supplied.

The memory 1510 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1510 includes one or more application programs 1514, such as an operating system, web browser application, a widget, gadget engine, or other application, and corresponding data 1516. The memory 1510 may store, for use by the UE 1500, any of a variety of various operating systems or combinations of operating systems.

The memory 1510 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1510 may allow the UE 1500 to access instructions, application programs and the like, stored on transitory or non-transitory memory media, to off-load data, or to upload data. An article of manufacture, such as one utilizing a communication system may be tangibly embodied as or in the memory 1510, which may be or comprise a device-readable storage medium.

The processing circuitry 1502 may be configured to communicate with an access network or other network using the communication interface 1512. The communication interface 1512 may comprise one or more communication subsystems and may include or be communicatively coupled to an antenna 1522. The communication interface 1512 may include one or more transceivers used to communicate, such as by communicating with one or more remote transceivers of another device capable of wireless communication (e.g., another UE or a network node in an access network). Each transceiver may include a transmitter 1518 and/or a receiver 1520 appropriate to provide network communications (e.g., optical, electrical, frequency allocations, and so forth). Moreover, the transmitter 1518 and receiver 1520 may be coupled to one or more antennas (e.g., antenna 1522) and may share circuit components, software or firmware, or alternatively be implemented separately.

In the illustrated embodiment, communication functions of the communication interface 1512 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1512, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1500 shown in FIG. 15.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 16 shows a network node 1600 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1600 includes a processing circuitry 1602, a memory 1604, a communication interface 1606, and a power source 1608. The network node 1600 may be composed of multiple physically separate components (e.g., a NodeB component and a RNC component, or a BTS component and a BSC component, etc.), which may each have their own respective components. In certain scenarios in which the network node 1600 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1600 may be configured to support multiple radio access technologies (RATs). In such embodiments, some components may be duplicated (e.g., separate memory 1604 for different RATs) and some components may be reused (e.g., a same antenna 1610 may be shared by different RATs). The network node 1600 may also include multiple sets of the various illustrated components for different wireless technologies integrated into network node 1600, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1600.

The processing circuitry 1602 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1600 components, such as the memory 1604, to provide network node 1600 functionality.

In some embodiments, the processing circuitry 1602 includes a system on a chip (SOC). In some embodiments, the processing circuitry 1602 includes one or more of radio frequency (RF) transceiver circuitry 1612 and baseband processing circuitry 1614. In some embodiments, the radio frequency (RF) transceiver circuitry 1612 and the baseband processing circuitry 1614 may be on separate chips (or sets of chips), boards, or units, such as radio units and digital units. In alternative embodiments, part or all of RF transceiver circuitry 1612 and baseband processing circuitry 1614 may be on the same chip or set of chips, boards, or units.

The memory 1604 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1602. The memory 1604 may store any suitable instructions, data, or information, including a computer program, software, an application including one or more of logic, rules, code, tables, and/or other instructions capable of being executed by the processing circuitry 1602 and utilized by the network node 1600. The memory 1604 may be used to store any calculations made by the processing circuitry 1602 and/or any data received via the communication interface 1606. In some embodiments, the processing circuitry 1602 and memory 1604 is integrated.

The communication interface 1606 is used in wired or wireless communication of signaling and/or data between a network node, access network, and/or UE. As illustrated, the communication interface 1606 comprises port(s)/terminal(s) 1616 to send and receive data, for example to and from a network over a wired connection. The communication interface 1606 also includes radio front-end circuitry 1618 that may be coupled to, or in certain embodiments a part of, the antenna 1610. Radio front-end circuitry 1618 comprises filters 1620 and amplifiers 1622. The radio front-end circuitry 1618 may be connected to an antenna 1610 and processing circuitry 1602. The radio front-end circuitry may be configured to condition signals communicated between antenna 1610 and processing circuitry 1602. The radio front-end circuitry 1618 may receive digital data that is to be sent out to other network nodes or UEs via a wireless connection. The radio front-end circuitry 1618 may convert the digital data into a radio signal having the appropriate channel and bandwidth parameters using a combination of filters 1620 and/or amplifiers 1622. The radio signal may then be transmitted via the antenna 1610. Similarly, when receiving data, the antenna 1610 may collect radio signals which are then converted into digital data by the radio front-end circuitry 1618. The digital data may be passed to the processing circuitry 1602. In other embodiments, the communication interface may comprise different components and/or different combinations of components.

In certain alternative embodiments, the network node 1600 does not include separate radio front-end circuitry 1618, instead, the processing circuitry 1602 includes radio front-end circuitry and is connected to the antenna 1610. Similarly, in some embodiments, all or some of the RF transceiver circuitry 1612 is part of the communication interface 1606. In still other embodiments, the communication interface 1606 includes one or more ports or terminals 1616, the radio front-end circuitry 1618, and the RF transceiver circuitry 1612, as part of a radio unit (not shown), and the communication interface 1606 communicates with the baseband processing circuitry 1614, which is part of a digital unit (not shown).

The antenna 1610 may include one or more antennas, or antenna arrays, configured to send and/or receive wireless signals. The antenna 1610 may be coupled to the radio front-end circuitry 1618 and may be any type of antenna capable of transmitting and receiving data and/or signals wirelessly. In certain embodiments, the antenna 1610 is separate from the network node 1600 and connectable to the network node 1600 through an interface or port.

The antenna 1610, communication interface 1606, and/or the processing circuitry 1602 may be configured to perform any receiving operations and/or certain obtaining operations described herein as being performed by the network node. Any information, data and/or signals may be received from a UE, another network node and/or any other network equipment. Similarly, the antenna 1610, the communication interface 1606, and/or the processing circuitry 1602 may be configured to perform any transmitting operations described herein as being performed by the network node. Any information, data and/or signals may be transmitted to a UE, another network node and/or any other network equipment.

The power source 1608 provides power to the various components of network node 1600 in a form suitable for the respective components (e.g., at a voltage and current level needed for each respective component). The power source 1608 may further comprise, or be coupled to, power management circuitry to supply the components of the network node 1600 with power for performing the functionality described herein. For example, the network node 1600 may be connectable to an external power source (e.g., the power grid, an electricity outlet) via an input circuitry or interface such as an electrical cable, whereby the external power source supplies power to power circuitry of the power source 1608. As a further example, the power source 1608 may comprise a source of power in the form of a battery or battery pack which is connected to, or integrated in, power circuitry. The battery may provide backup power should the external power source fail.

Embodiments of the network node 1600 may include additional components beyond those shown in FIG. 16 for providing certain aspects of the network node's functionality, including any of the functionality described herein and/or any functionality necessary to support the subject matter described herein. For example, the network node 1600 may include user interface equipment to allow input of information into the network node 1600 and to allow output of information from the network node 1600. This may allow a user to perform diagnostic, maintenance, repair, and other administrative functions for the network node 1600.

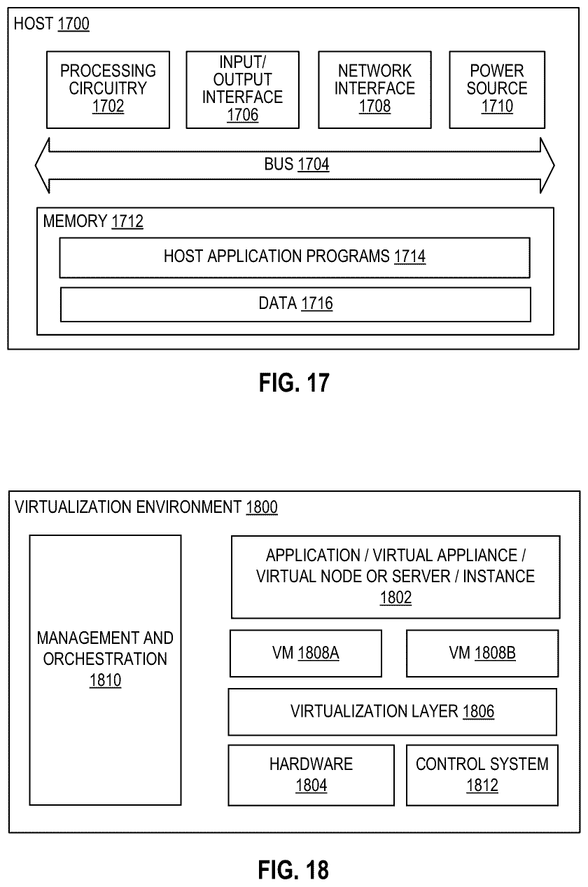

FIG. 17 is a block diagram of a host 1700, which may be an embodiment of the host 1416 of FIG. 14, in accordance with various aspects described herein. As used herein, the host 1700 may be or comprise various combinations hardware and/or software, including a standalone server, a blade server, a cloud-implemented server, a distributed server, a virtual machine, container, or processing resources in a server farm. The host 1700 may provide one or more services to one or more UEs.

The host 1700 includes processing circuitry 1702 that is operatively coupled via a bus 1704 to an input/output interface 1706, a network interface 1708, a power source 1710, and a memory 1712. Other components may be included in other embodiments. Features of these components may be substantially similar to those described with respect to the devices of previous figures, such as FIGS. 15 and 16, such that the descriptions thereof are generally applicable to the corresponding components of host 1700.

The memory 1712 may include one or more computer programs including one or more host application programs 1714 and data 1716, which may include user data, e.g., data generated by a UE for the host 1700 or data generated by the host 1700 for a UE. Embodiments of the host 1700 may utilize only a subset or all of the components shown. The host application programs 1714 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1714 may also provide for user authentication and licensing checks and may periodically report health, routes, and content availability to a central node, such as a device in or on the edge of a core network. Accordingly, the host 1700 may select and/or indicate a different host for over-the-top services for a UE. The host application programs 1714 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 18 is a block diagram illustrating a virtualization environment 1800 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1800 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1802 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1804 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1806 (also referred to as hypervisors or virtual machine monitors (VMMs)), provide VMs 1808a and 1808b (one or more of which may be generally referred to as VMs 1808), and/or perform any of the functions, features and/or benefits described in relation with some embodiments described herein. The virtualization layer 1806 may present a virtual operating platform that appears like networking hardware to the VMs 1808.

The VMs 1808 comprise virtual processing, virtual memory, virtual networking or interface and virtual storage, and may be run by a corresponding virtualization layer 1806. Different embodiments of the instance of a virtual appliance 1802 may be implemented on one or more of VMs 1808, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1808 may be a software implementation of a physical machine that runs programs as if they were executing on a physical, non-virtualized machine. Each of the VMs 1808, and that part of hardware 1804 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1808 on top of the hardware 1804 and corresponds to the application 1802.

Hardware 1804 may be implemented in a standalone network node with generic or specific components. Hardware 1804 may implement some functions via virtualization. Alternatively, hardware 1804 may be part of a larger cluster of hardware (e.g. such as in a data center or CPE) where many hardware nodes work together and are managed via management and orchestration 1810, which, among others, oversees lifecycle management of applications 1802. In some embodiments, hardware 1804 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1812 which may alternatively be used for communication between hardware nodes and radio units.

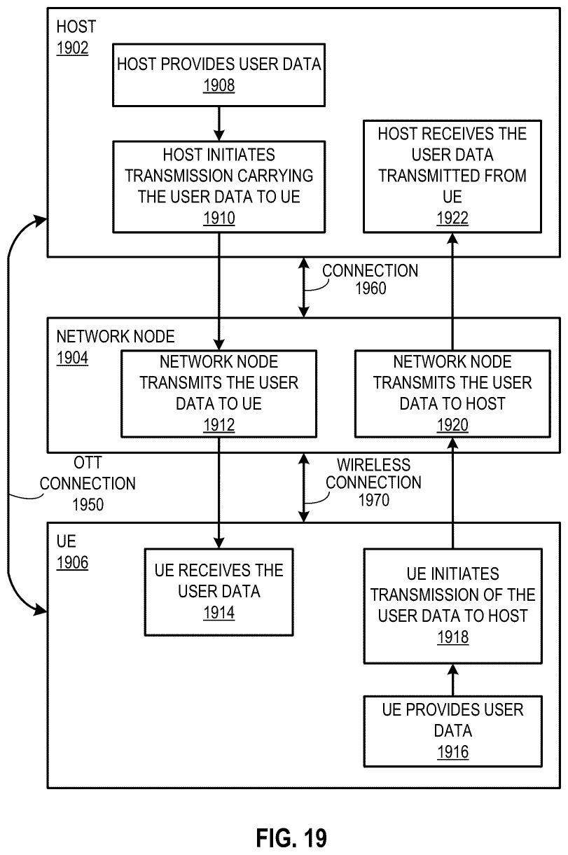

FIG. 19 shows a communication diagram of a host 1902 communicating via a network node 1904 with a UE 1906 over a partially wireless connection in accordance with some embodiments. Example implementations, in accordance with various embodiments, of the UE (such as a UE 1412a of FIG. 14 and/or UE 1500 of FIG. 15), network node (such as network node 1410a of FIG. 14 and/or network node 1600 of FIG. 16), and host (such as host 1416 of FIG. 14 and/or host 1700 of FIG. 17) discussed in the preceding paragraphs will now be described with reference to FIG. 19.

Like host 1700, embodiments of host 1902 include hardware, such as a communication interface, processing circuitry, and memory. The host 1902 also includes software, which is stored in or accessible by the host 1902 and executable by the processing circuitry. The software includes a host application that may be operable to provide a service to a remote user, such as the UE 1906 connecting via an over-the-top (OTT) connection 1950 extending between the UE 1906 and host 1902. In providing the service to the remote user, a host application may provide user data which is transmitted using the OTT connection 1950.

The network node 1904 includes hardware enabling it to communicate with the host 1902 and UE 1906. The connection 1960 may be direct or pass through a core network (like core network 1406 of FIG. 14) and/or one or more other intermediate networks, such as one or more public, private, or hosted networks. For example, an intermediate network may be a backbone network or the Internet.

The UE 1906 includes hardware and software, which is stored in or accessible by UE 1906 and executable by the UE's processing circuitry. The software includes a client application, such as a web browser or operator-specific “app” that may be operable to provide a service to a human or non-human user via UE 1906 with the support of the host 1902. In the host 1902, an executing host application may communicate with the executing client application via the OTT connection 1950 terminating at the UE 1906 and host 1902. In providing the service to the user, the UE's client application may receive request data from the host's host application and provide user data in response to the request data. The OTT connection 1950 may transfer both the request data and the user data. The UE's client application may interact with the user to generate the user data that it provides to the host application through the OTT connection 1950.

The OTT connection 1950 may extend via a connection 1960 between the host 1902 and the network node 1904 and via a wireless connection 1970 between the network node 1904 and the UE 1906 to provide the connection between the host 1902 and the UE 1906. The connection 1960 and wireless connection 1970, over which the OTT connection 1950 may be provided, have been drawn abstractly to illustrate the communication between the host 1902 and the UE 1906 via the network node 1904, without explicit reference to any intermediary devices and the precise routing of messages via these devices.

As an example of transmitting data via the OTT connection 1950, in step 1908, the host 1902 provides user data, which may be performed by executing a host application. In some embodiments, the user data is associated with a particular human user interacting with the UE 1906. In other embodiments, the user data is associated with a UE 1906 that shares data with the host 1902 without explicit human interaction. In step 1910, the host 1902 initiates a transmission carrying the user data towards the UE 1906. The host 1902 may initiate the transmission responsive to a request transmitted by the UE 1906. The request may be caused by human interaction with the UE 1906 or by operation of the client application executing on the UE 1906. The transmission may pass via the network node 1904, in accordance with the teachings of the embodiments described throughout this disclosure. Accordingly, in step 1912, the network node 1904 transmits to the UE 1906 the user data that was carried in the transmission that the host 1902 initiated, in accordance with the teachings of the embodiments described throughout this disclosure. In step 1914, the UE 1906 receives the user data carried in the transmission, which may be performed by a client application executed on the UE 1906 associated with the host application executed by the host 1902.

In some examples, the UE 1906 executes a client application which provides user data to the host 1902. The user data may be provided in reaction or response to the data received from the host 1902. Accordingly, in step 1916, the UE 1906 may provide user data, which may be performed by executing the client application. In providing the user data, the client application may further consider user input received from the user via an input/output interface of the UE 1906. Regardless of the specific manner in which the user data was provided, the UE 1906 initiates, in step 1918, transmission of the user data towards the host 1902 via the network node 1904. In step 1920, in accordance with the teachings of the embodiments described throughout this disclosure, the network node 1904 receives user data from the UE 1906 and initiates transmission of the received user data towards the host 1902. In step 1922, the host 1902 receives the user data carried in the transmission initiated by the UE 1906.

One or more of the various embodiments improve the performance of OTT services provided to the UE 1906 using the OTT connection 1950, in which the wireless connection 1970 forms the last segment.

In an example scenario, factory status information may be collected and analyzed by the host 1902. As another example, the host 1902 may process audio and video data which may have been retrieved from a UE for use in creating maps. As another example, the host 1902 may collect and analyze real-time data to assist in controlling vehicle congestion (e.g., controlling traffic lights). As another example, the host 1902 may store surveillance video uploaded by a UE. As another example, the host 1902 may store or control access to media content such as video, audio, VR or AR which it can broadcast, multicast or unicast to UEs. As other examples, the host 1902 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1950 between the host 1902 and UE 1906, in response to variations in the measurement results. The measurement procedure and/or the network functionality for reconfiguring the OTT connection may be implemented in software and hardware of the host 1902 and/or UE 1906. In some embodiments, sensors (not shown) may be deployed in or in association with other devices through which the OTT connection 1950 passes; the sensors may participate in the measurement procedure by supplying values of the monitored quantities exemplified above, or supplying values of other physical quantities from which software may compute or estimate the monitored quantities. The reconfiguring of the OTT connection 1950 may include message format, retransmission settings, preferred routing etc.; the reconfiguring need not directly alter the operation of the network node 1904. Such procedures and functionalities may be known and practiced in the art. In certain embodiments, measurements may involve proprietary UE signaling that facilitates measurements of throughput, propagation times, latency and the like, by the host 1902. The measurements may be implemented in that software causes messages to be transmitted, in particular empty or ‘dummy’ messages, using the OTT connection 1950 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

Example embodiments of the techniques and apparatus described herein include, but are not limited to, the following enumerated examples:

### Group A Embodiments

A1. A method performed by a network node configured for use in a communication network, the method comprising:
obtaining downlink measurement reports that are reported by communication devices to a serving cell and that each reports a downlink measurement on the serving cell and a downlink measurement on a neighbor cell;
obtaining serving cell resource information indicating, for each of the communication devices, a number of transmission resources utilized by the communication device for uplink traffic on the serving cell;
obtaining neighbor cell resource information indicating a number of transmission resources available for uplink traffic on the neighbor cell and a number of transmission resources utilized for uplink traffic on the neighbor cell; and
calculating, from the downlink measurement reports, the serving cell resource information, and the neighbor cell resource information, an uplink coupling factor that indicates an extent to which uplink traffic on the serving cell interferes with uplink traffic on the neighbor cell.

A2. The method of embodiment A1, wherein calculating the uplink coupling factor comprises:
selecting, from the downlink measurement reports, a subset of downlink measurement reports that, assuming downlink-uplink reciprocity, each indicate uplink traffic on the serving cell interferes with uplink traffic on the neighbor cell;
for each downlink measurement report in the subset, calculating, as a function of the serving cell resource information and the neighbor cell resource information, an uplink coupling factor component associated with the downlink measurement report; and
calculating the uplink coupling factor as a function of the uplink coupling factor components.

A3. The method of embodiment A2, wherein calculating the uplink coupling factor component for each downlink measurement report in the subset comprises, for each downlink measurement report in the subset:
determining, as a function of the serving cell resource information, a number of transmission resources associated with the downlink measurement report; and
calculating the uplink coupling factor component associated with the downlink measurement report as a function of the number of transmission resources associated with the downlink measurement report.

A4. The method of embodiment A3, wherein calculating the uplink coupling factor component for each downlink measurement report in the subset comprises, for each downlink measurement report in the subset:
calculating a report-specific resource utilization metric as a function of the number of transmission resources associated with the downlink measurement report; and
calculating the uplink coupling factor component associated with the downlink measurement report as a function of the report-specific resource utilization metric.

A5. The method of embodiment A4, wherein the serving cell resource information also indicates a number of transmission resources available for uplink traffic on the serving cell, and wherein the report-specific resource utilization metric calculated for a downlink measurement report in the subset is a ratio between:
the number of transmission resources associated with the downlink measurement report; and
the number of transmission resources available for uplink traffic on the serving cell.

A6. The method of any of embodiments A3-A5, wherein the serving cell resource information indicates, for each of the communication devices and for each of multiple resource information event periods, a number of transmission resources utilized by the communication device for uplink traffic on the serving cell during the resource information event period, wherein the number of transmission resources available for uplink traffic on the serving cell is the number of transmission resources available for uplink traffic on the serving cell across the multiple resource information event periods, and wherein, for each downlink measurement report in the subset, determining the number of transmission resources associated with the downlink measurement report comprises:
determining, from among the multiple resource information event periods, a resource information event period within which the downlink measurement report was reported;
determining a set of one or more downlink measurement reports reported within the determined resource information event period;
determining a number of transmission resources associated with the set as a function of the number of transmission resources utilized during the determined resource information event period for uplink traffic on the serving cell by the communication device which reported the downlink measurement report; and
equally distributing the number of transmission resources associated with the set among the one or more downlink measurement reports included in the set, with each downlink measurement report included in the set being associated with the number of transmission resources distributed to that downlink measurement report.

A7. The method of embodiment A6, wherein determining the number of transmission resources associated with the set comprises:
scaling, by a scaling factor, the number of transmission resources utilized during the determined resource information event period for uplink traffic on the serving cell by the communication device which reported the downlink measurement report; and
determining the number of transmission resources associated with the set to be equal to the scaled number.

A8. The method of embodiment A7, wherein the serving cell resource information also indicates, for each of the multiple resource information event periods, a number of transmission resources utilized for uplink traffic on the serving cell collectively by communication devices served by the serving cell during the resource information event period, wherein the scaling factor is a ratio of:
the number of transmission resources utilized for uplink traffic on the serving cell collectively by communication devices served by the serving cell during the determined resource information event period; and
a sum of the numbers of transmission resources respectively utilized by the communication devices for uplink traffic on the serving cell during the resource information event period.

A9. The method of any of embodiments A4-A8, wherein calculating the uplink coupling factor component associated with the downlink measurement report as a function of the report-specific resource utilization metric comprises calculating the uplink coupling factor component associated with the downlink measurement report to be proportional to the report-specific resource utilization metric.

A10. The method of any of embodiments A2-A9, wherein calculating the uplink coupling factor component for each downlink measurement report in the subset comprises, for each downlink measurement report in the subset, calculating the uplink coupling factor component associated with the downlink measurement report also as a function of the number of transmission resources utilized for uplink traffic on the neighbor cell.

A11. The method of embodiment A10, wherein calculating the uplink coupling factor component for each downlink measurement report in the subset comprises, for each downlink measurement report in the subset:
calculating a neighbor cell resource utilization metric as a function of the number of transmission resources available for uplink traffic on the neighbor cell and the number of transmission resources utilized for uplink traffic on the neighbor cell; and
calculating the uplink coupling factor component associated with the downlink measurement report as a function of the neighbor cell resource utilization metric.

A12. The method of embodiment A11, wherein the neighbor cell resource utilization metric is a ratio of the number of transmission resources utilized for uplink traffic on the neighbor cell to the number of transmission resources available for uplink traffic on the neighbor cell.

A13. The method of any of embodiments A11-A12, wherein calculating the uplink coupling factor component associated with the downlink measurement report as a function of the neighbor cell resource utilization metric comprises calculating the uplink coupling factor component associated with the downlink measurement report to be proportional to the neighbor cell resource utilization metric.

A14. The method of any of embodiments A2-A13, wherein calculating the uplink coupling factor as a function of the uplink coupling factor components comprises calculating the uplink coupling factor as a sum of the uplink coupling factor components.

A15. The method of any of embodiments A2-A14, wherein selecting the subset of downlink measurement reports comprises, for each of the downlink measurement reports:
calculating, as a function of the downlink measurements on the serving cell and the neighbor cell reported by the downlink measurement report, and as a function of uplink-downlink reciprocity information, a metric representing a relation between an uplink measurement on the serving cell and an uplink measurement on the neighbor cell; and
selecting the downlink measurement report for inclusion in the subset if the metric is less than a threshold.

A16. The method of embodiment A15, wherein the relation is a ratio in a linear domain.

A17. The method of any of embodiments A15-A16, wherein the uplink-downlink reciprocity information includes:
a maximum transmission power on the serving cell; and
a power offset between power to be applied to transmission resources carrying a reference signal measured by downlink measurements on the serving cell and power to be applied to transmission resources not carrying the reference signal.

A18. The method of any of embodiments A1-A17, further comprising controlling uplink power in the serving cell based on the uplink coupling factor.

A19. The method of embodiment A18, wherein said controlling comprises generating a model of uplink power in the serving cell using the uplink coupling factor and controlling uplink power in the serving cell based on the model.

A20. The method of any of embodiments A1-A19, further comprising transmitting the uplink coupling factor to another node in the communication network.

A21. The method of any of embodiments A1-A20, wherein the serving cell resource information indicates, for each of the communication devices and for each of multiple resource information event periods, a number of transmission resources utilized by the communication device for uplink traffic on the serving cell during the resource information event period, and wherein obtaining the serving cell resource information comprises:
obtaining device resource information indicating, for each of the communication devices and for each of multiple device information event periods, a number of transmission resources utilized by the communication device for uplink traffic on the serving cell during the device information event period; and
obtaining the serving cell resource information by, for each of the communication devices and for each of the multiple resource information event periods:
   determining a set of device information event periods for the communication device that occur during the resource information event period; and
   calculating the number of transmission resources utilized by the communication device for uplink traffic on the serving cell during the resource information event period by aggregating the numbers of the transmission resources utilized by the communication device for uplink traffic on the serving cell during the respective device information event periods in the determined set.

A22. The method of embodiment A21, wherein the serving cell resource information also indicates, for each of the multiple resource information event periods, a number of transmission resources utilized for uplink traffic on the serving cell collectively by communication devices served by the serving cell during the resource information event period.

### Group B Embodiments

B1. A network node configured to perform any of the steps of any of the Group A embodiments.

B2. A network node comprising processing circuitry configured to perform any of the steps of any of the Group A embodiments.

B3. A network node comprising:
communication circuitry; and
processing circuitry configured to perform any of the steps of any of the Group A embodiments.

B4. A network node comprising:
processing circuitry configured to perform any of the steps of any of the Group A embodiments;
power supply circuitry configured to supply power to the network node.

B5. A network node comprising:
processing circuitry and memory, the memory containing instructions executable by the processing circuitry whereby the network node is configured to perform any of the steps of any of the Group A embodiments.

B6. The network node of any of embodiments B1-B5, wherein the network node is a base station.

B7. A computer program comprising instructions which, when executed by at least one processor of a network node, causes the network node to carry out the steps of any of the Group A embodiments.

B8. The computer program of embodiment B7, wherein the network node is a base station.

B9. A carrier containing the computer program of any of embodiments B7-B8, wherein the carrier is one of an electronic signal, optical signal, radio signal, or computer readable storage medium.

1. A method performed by a network node configured for use in a communication network, the method comprising:
obtaining downlink measurement reports that are reported by communication devices to a serving cell and that each reports a downlink measurement on the serving cell and a downlink measurement on a neighbor cell;
obtaining serving cell resource information indicating, for each of the communication devices, a number of transmission resources utilized by the communication device for uplink traffic on the serving cell;
obtaining neighbor cell resource information indicating a number of transmission resources available for uplink traffic on the neighbor cell and a number of transmission resources utilized for uplink traffic on the neighbor cell; and
calculating, from the downlink measurement reports, the serving cell resource information, and the neighbor cell resource information, an uplink coupling factor that indicates an extent to which uplink traffic on the serving cell interferes with uplink traffic on the neighbor cell.

2. The method of claim 1, wherein calculating the uplink coupling factor comprises:
selecting, from the downlink measurement reports, a subset of downlink measurement reports that, assuming downlink-uplink reciprocity, each indicate uplink traffic on the serving cell interferes with uplink traffic on the neighbor cell;
for each downlink measurement report in the subset, calculating, as a function of the serving cell resource information and the neighbor cell resource information, an uplink coupling factor component associated with the downlink measurement report; and
calculating the uplink coupling factor as a function of the uplink coupling factor components.

3. The method of claim 2, wherein calculating the uplink coupling factor component for each downlink measurement report in the subset comprises, for each downlink measurement report in the subset:
determining, as a function of the serving cell resource information, a number of transmission resources associated with the downlink measurement report; and
calculating the uplink coupling factor component associated with the downlink measurement report as a function of the number of transmission resources associated with the downlink measurement report.

4. The method of claim 3, wherein calculating the uplink coupling factor component for each downlink measurement report in the subset comprises, for each downlink measurement report in the subset:
calculating a report-specific resource utilization metric as a function of the number of transmission resources associated with the downlink measurement report; and
calculating the uplink coupling factor component associated with the downlink measurement report as a function of the report-specific resource utilization metric.

5. The method of claim 4, wherein the serving cell resource information also indicates a number of transmission resources available for uplink traffic on the serving cell, and wherein the report-specific resource utilization metric calculated for a downlink measurement report in the subset is a ratio between:
the number of transmission resources associated with the downlink measurement report; and
the number of transmission resources available for uplink traffic on the serving cell.

6. The method of claim 3, wherein the serving cell resource information indicates, for each of the communication devices and for each of multiple resource information event periods, a number of transmission resources utilized by the communication device for uplink traffic on the serving cell during the resource information event period, wherein the number of transmission resources available for uplink traffic on the serving cell is the number of transmission resources available for uplink traffic on the serving cell across the multiple resource information event periods, and wherein, for each downlink measurement report in the subset, determining the number of transmission resources associated with the downlink measurement report comprises:
determining, from among the multiple resource information event periods, a resource information event period within which the downlink measurement report was reported;
determining a set of one or more downlink measurement reports reported within the determined resource information event period;
determining a number of transmission resources associated with the set as a function of the number of transmission resources utilized during the determined resource information event period for uplink traffic on the serving cell by the communication device which reported the downlink measurement report; and
equally distributing the number of transmission resources associated with the set among the one or more downlink measurement reports included in the set, with each downlink measurement report included in the set being associated with the number of transmission resources distributed to that downlink measurement report.

7. The method of claim 6, wherein determining the number of transmission resources associated with the set comprises:
scaling, by a scaling factor, the number of transmission resources utilized during the determined resource information event period for uplink traffic on the serving cell by the communication device which reported the downlink measurement report; and
determining the number of transmission resources associated with the set to be equal to the scaled number.

8. The method of claim 7, wherein the serving cell resource information also indicates, for each of the multiple resource information event periods, a number of transmission resources utilized for uplink traffic on the serving cell collectively by communication devices served by the serving cell during the resource information event period, wherein the scaling factor is a ratio of:
the number of transmission resources utilized for uplink traffic on the serving cell collectively by communication devices served by the serving cell during the determined resource information event period; and
a sum of the numbers of transmission resources respectively utilized by the communication devices for uplink traffic on the serving cell during the resource information event period.

9. The method of claim 4, wherein calculating the uplink coupling factor component associated with the downlink measurement report as a function of the report-specific resource utilization metric comprises calculating the uplink coupling factor component associated with the downlink measurement report to be proportional to the report-specific resource utilization metric.

10. The method of claim 2, wherein calculating the uplink coupling factor component for each downlink measurement report in the subset comprises, for each downlink measurement report in the subset, calculating the uplink coupling factor component associated with the downlink measurement report also as a function of the number of transmission resources utilized for uplink traffic on the neighbor cell.

11. The method of claim 10, wherein calculating the uplink coupling factor component for each downlink measurement report in the subset comprises, for each downlink measurement report in the subset:
calculating a neighbor cell resource utilization metric as a function of the number of transmission resources available for uplink traffic on the neighbor cell and the number of transmission resources utilized for uplink traffic on the neighbor cell, wherein the neighbor cell resource utilization metric is a ratio of the number of transmission resources utilized for uplink traffic on the neighbor cell to the number of transmission resources available for uplink traffic on the neighbor cell; and
calculating the uplink coupling factor component associated with the downlink measurement report to be proportional to the neighbor cell resource utilization metric.

12. The method of claim 2, wherein calculating the uplink coupling factor as a function of the uplink coupling factor components comprises calculating the uplink coupling factor as a sum of the uplink coupling factor components.

13. The method of claim 2, wherein selecting the subset of downlink measurement reports comprises, for each of the downlink measurement reports:
calculating, as a function of the downlink measurements on the serving cell and the neighbor cell reported by the downlink measurement report, and as a function of uplink-downlink reciprocity information, a metric representing a relation between an uplink measurement on the serving cell and an uplink measurement on the neighbor cell; and
selecting the downlink measurement report for inclusion in the subset if the metric is less than a threshold.

14. The method of claim 13, wherein the uplink-downlink reciprocity information includes:
a maximum transmission power on the serving cell; and
a power offset between power to be applied to transmission resources carrying a reference signal measured by downlink measurements on the serving cell and power to be applied to transmission resources not carrying the reference signal.

15. The method of claim 1, further comprising controlling uplink power in the serving cell based on the uplink coupling factor.

16. The method of claim 15, wherein said controlling comprises generating a model of uplink power in the serving cell using the uplink coupling factor and controlling uplink power in the serving cell based on the model.

17. The method of claim 1, wherein the serving cell resource information indicates, for each of the communication devices and for each of multiple resource information event periods, a number of transmission resources utilized by the communication device for uplink traffic on the serving cell during the resource information event period, and wherein obtaining the serving cell resource information comprises:
obtaining device resource information indicating, for each of the communication devices and for each of multiple device information event periods, a number of transmission resources utilized by the communication device for uplink traffic on the serving cell during the device information event period; and
obtaining the serving cell resource information by, for each of the communication devices and for each of the multiple resource information event periods:
determining a set of device information event periods for the communication device that occur during the resource information event period; and
calculating the number of transmission resources utilized by the communication device for uplink traffic on the serving cell during the resource information event period by aggregating the numbers of the transmission resources utilized by the communication device for uplink traffic on the serving cell during the respective device information event periods in the determined set.

18. The method of claim 17, wherein the serving cell resource information also indicates, for each of the multiple resource information event periods, a number of transmission resources utilized for uplink traffic on the serving cell collectively by communication devices served by the serving cell during the resource information event period.

19. A network node configured for use in a communication network, the network node configured to:
obtain downlink measurement reports that are reported by communication devices to a serving cell and that each reports a downlink measurement on the serving cell and a downlink measurement on a neighbor cell;
obtain serving cell resource information indicating, for each of the communication devices, a number of transmission resources utilized by the communication device for uplink traffic on the serving cell;
obtain neighbor cell resource information indicating a number of transmission resources available for uplink traffic on the neighbor cell and a number of transmission resources utilized for uplink traffic on the neighbor cell; and
calculate, from the downlink measurement reports, the serving cell resource information, and the neighbor cell resource information, an uplink coupling factor that indicates an extent to which uplink traffic on the serving cell interferes with uplink traffic on the neighbor cell.

20. (canceled)

21. A non-transitory computer-readable medium storing thereon a computer program comprising instructions which, when executed by at least one processor of a network node, cause the network node to perform the method of claim 1.

22-24. (canceled)
